(19) United States
(12) Patent Application Publication
(10) Pub. No.: US 2014/0362675 A1
(43) Pub. Date: Dec. 11, 2014

(54) EXPOSURE DEVICE, RECORDING MEDIUM, RECORDING DEVICE, AND REPRODUCING DEVICE

(71) Applicants: Sony Corporation, Tokyo (JP); c/o Sony DADC Corporation, Tokyo (JP)

(72) Inventors: Kensaku Takahashi, Kanagawa (JP); Akiya Saito, Kanagawa (JP); Eiki Yamashita, Kanagawa (JP)

(73) Assignees: Sony Corporation, Tokyo (JP); c/o Sony DADC Corporation, Tokyo (JP)

(21) Appl. No.: 14/362,658

(22) PCT Filed: Dec. 12, 2012
(86) PCT No.: PCT/JP2012/082165

§ 371 Date: Jun. 4, 2014

(30) Foreign Application Priority Data
Dec. 20, 2011 (JP) 2011-278539

(51) Int. Cl. G11B 7/24073; G11B 7/0037

(52) U.S. Cl. CPC G11B 7/24073; G11B 7/0037
USPC 369/47.38; 369/275.4

(57) ABSTRACT

There is provided a recording medium including: simple tracks each configured of arranged pits or arranged marks; and grooved tracks each configured of pits or marks and grooves, the grooves being inserted between the pits or between the marks. The simple tracks and the grooved tracks are arranged alternately in a radial direction at a track pitch of 0.27 micrometers or smaller.

### TECHNICAL FIELD

The present technology relates to an exposure device for performing exposure operation of a master disc that is used for manufacturing an optical disc recording medium, and relates to a recording medium. Also, the present technology relates to a recording device that performs recording operation on a recordable-type recording medium that includes a recording layer in which mark recording is allowed to be performed in response to laser light irradiation, and relates to a reproducing device that performs reproducing operation of a recording medium.

### CITATION LIST

### Patent Literature

Patent Literature 1: Japanese Unexamined Patent Application Publication No. 2007-226965

Patent Literature 2: Japanese Unexamined Patent Application Publication No. 2002-123982

### BACKGROUND ART

As an optical recording medium in which recording or reproducing operation of a signal is performed by irradiation of light, for example, a so-called optical disc recording medium (hereinafter, may be also simply described as “optical disc”) such as a CD (Compact Disc), a DVD (Digital Versatile Disc), and a BD (Blu-ray Disc: registered trademark) is widely used.

Increase in recording capacity of the optical disc has been achieved by improving information recording density of the optical disc. For improving the information recording density, there is adopted a method in which a formation pitch of tracks as pit lines or mark lines is reduced, in other words, a method of improving recording density in a radial direction. Also, there is adopted a method of improving recording density in a linear direction (a direction orthogonal to the radial direction) by reducing size of the pit or the mark.

### SUMMARY OF THE INVENTION

However, it is desirable to consider that there is a limit in spatial resolution in the method in which the track pitch is reduced in order to improve information recording density.

For example, in a case of the BD, optical conditions for recording and reproducing operation are to be: recording-reproducing wavelength λ=about 405 nm; and numerical aperture NA of an objective lens=about 0.85. However, when a tracking error detection method which is a related technology is adopted, a tracing error signal amplitude is not allowed to be obtained when the track pitch is reduced to λ/2 NA or smaller (about 0.238 μm or smaller in the case of the BD). Accordingly, tracking error is hardly detected. In other words, tracking servo operation is not allowed to be performed. As a result, information recorded at high density is not allowed to be reproduced at all.

In this case, the above-mentioned “λ/2 NA” is a theoretical value. Taking into consideration actual degradation factors such as optical noise, a limit value of the track pitch that allows appropriate detection of a tracking error becomes larger. For example, in the case of the BD, the limit value of the track pitch is about 0.27 μm.

In such a case where the tracking error detection method which is the related technology is adopted, it is difficult to reduce the track pitch out of the limit value due to the existence of the optical limit value. In other words, depending on the method in the related technology, there is a limit in improving the information recording density by reducing the track pitch, and it is extremely difficult to further increase the recording capacity.

Therefore, it is desirable to allow tracking servo operation to be performed appropriately under a state where the tracks are arranged at a pitch out of the optical limit value, and thereby to further improve information recording density.

In order to solve the above-described problem, an exposure device according to an embodiment of the present technology is configured as follows.

Specifically, the exposure device includes a rotation drive section driving a master disc to rotate. Also, the exposure device includes

an exposure section performing exposure operation on the master disc under rotation by the rotation drive section, the exposure section thereby allowing simple pit lines and grooved pit lines to be arranged alternately in a radial direction at a track pitch of 0.27 micrometers or smaller, the simple pit lines each being configured of arranged pits, and the grooved pit lines each being configured of pits and grooves, the grooves being inserted between the pits.

Moreover, a recording medium according to an embodiment of the present technology is configured as follows.

Specifically, the recording medium includes: simple tracks each configured of arranged pits or arranged marks; and grooved tracks each configured of pits or marks and grooves, the grooves being inserted between the pits or between the marks. The simple tracks and the grooved tracks are arranged alternately in a radial direction at a track pitch of 0.27 micrometers or smaller.

Moreover, a recording device according to an embodiment of the present technology is configured as follows.

Specifically, the recording device includes a recording section performing recording operation on a recording layer of a recording medium, the recording section thereby allowing simple mark lines and grooved mark lines to be arranged alternately in a radial direction of the recording medium at a track pitch of 0.27 micrometers or smaller, the simple mark lines being each configured of arranged marks, and the grooved mark lines being each configured of marks and grooves, the grooves being inserted between the marks.

Moreover, a reproducing device according to an embodiment of the present technology is configured as follows.

Specifically, the reproducing device includes a light irradiation-reception section irradiating laser light to a recording medium through an objective lens and receiving reflected light of the irradiated laser light, the recording medium including simple tracks and grooved tracks arranged alternately in a radial direction at a track pitch of 0.27 micrometers or smaller, the simple tracks being configured of arranged pits or arranged marks, and the grooved tracks being configured of pits or marks and grooves, the grooves being inserted between the pits or between the marks.

Also, the reproducing device includes a tracking error signal generation section generating a tracking error signal based on a light reception signal derived from the reflected light received by the light irradiation-reception section.

Also, the reproducing device includes a position control section controlling a position of the objective lens in a tracking direction based on the tracking error signal, and thereby controlling a position of the laser light in the radial direction, the tracking direction being a direction parallel to the radial direction.

Also, the reproducing device includes a reproducing section performing reproduction operation of a recorded signal from the recording medium based on the light reception signal.

According to the above-described embodiment of the present technology, in the recording medium, the simple tracks including the arranged pits or arranged marks and the grooved tracks including the pits or marks and the grooves inserted therebetween are arranged alternately in the radial direction at a track pitch of 0.27 μm or smaller.

Due to the formation of the grooves, the amplitude of the tracking error signal is obtained more largely in the grooved track. On the other hand, in the simple track in which no groove is formed, the track pitch is set to 0.27 μm or smaller (the pitch out of the actual optical limit value). Therefore, amplitude of the tracking error signal is hardly obtained.

Based on these points, according to the above-described present technology, the amplitude of the tracking error signal is obtainable almost only in correspondence with the grooved track. In other words, a tracking error signal is obtainable that is almost similar to that in a case where only the grooved tracks are formed on an optical disc recording medium. In other words, a tracking error signal is obtainable that is almost similar to that in a case where a track pitch that is twice as large as the actual track pitch is set.

Since the amplitude of the tracking error signal is obtainable only in correspondence with the grooved track in such a manner, it is possible to stably perform tracking servo operation. In other words, tracking servo operation is allowed to be appropriately performed in a case where the tracks are arranged at a pitch out of the optical limit value.

In this case, performing tracking servo operation in different manners between for the simple track in which no groove is formed and for the grooved track is achieved by performing switching as follows which will be described later. That is, at the time of performing position control targeting the simple track, position control is performed based on a signal (a first control signal) obtained by performing polarity inversion or offset on the tracking error signal. At the time of performing position control targeting the grooved track, position control is performed based on a signal (a second control signal) in which no polarity inversion or offset is performed on the tracking error signal.

According to an embodiment of the present disclosure as described above, tracking servo operation is allowed to be appropriately performed under a state where the tracks are arranged at a pitch out of the optical limit value. Consequently, as a result, information recording density is further improved.

### BRIEF DESCRIPTION OF THE DRAWINGS

FIG. 1 is a diagram illustrating SUM signals and push-pull signals observed when a track pitch is gradually reduced from 0.32 μm to 0.27 μm and 0.23 μm.

FIG. 2 is a diagram illustrating 0-order light and diffracted light (+1-order light and −1-order light of laser light).

FIG. 3A is a diagram for explaining a structure of tracks formed on an optical disc recording medium according to an embodiment.

FIG. 3B is a diagram for explaining the structure of the tracks formed on the optical disc recording medium according to an embodiment.

FIG. 4A is a diagram illustrating a relationship between the respective tracks and an NPP signal amplitude when a track pitch is 0.32 μm in a case where the tracks are formed in the arrangement shown in FIG. 3A.

FIG. 4B is a diagram illustrating a relationship between the respective tracks an NPP signal amplitude when a track pitch is 0.27 μm or smaller in the case where the tracks are formed in the arrangement shown in FIG. 3A.

FIG. 5 is a diagram illustrating a relationship in more detail between the NPP signal amplitude and grooved tracks T-g and the no-groove tracks T-s.

FIG. 6 is a diagram for explaining a manufacturing process of an optical disc recording medium in a first embodiment.

FIG. 7 is a diagram illustrating an internal configuration example of an exposure device in the first embodiment.

FIG. 8 is a diagram for explaining a method of performing switching between recording of grooved tracks and recording of no-groove tracks.

FIG. 9 is a flowchart showing steps of specific processes to be executed in order to achieve the method of switching recording operation in the first embodiment.

FIG. 10 is a diagram illustrating an internal configuration example of a reproducing device that performs reproduction of the optical disc recording medium of the first embodiment.

FIG. 11A is a diagram exemplarily illustrating an internal configuration of a servo circuit.

FIG. 11B is a diagram exemplarily illustrating an internal configuration of a servo circuit.

FIG. 12 is a flowchart showing steps of specific processes to be executed in order to achieve performing tracking servo operation for the grooved track and the no-groove track in different manners.

FIG. 13 is a diagram for explaining an internal configuration example of an exposure device in a second embodiment.

FIG. 14 is a diagram for explaining an internal configuration example of a reproducing device of the second embodiment.

FIG. 15 is a cross-sectional structure diagram of an optical disc recording medium targeted for recording in a third embodiment.

FIG. 16 is a diagram for explaining a position control method utilizing a position guide formed on a reference surface.

FIG. 17 is a diagram (a planar view) illustrating, in a partially-enlarged manner, a surface of the reference surface of the optical disc recording medium of the third embodiment.

FIG. 18 is a diagram for explaining a specific method of forming pits in the entire reference surface.

FIG. 19 is a diagram schematically illustrating a relationship between a state of a spot of the servo laser light that moves on the reference surface in accordance with rotation of the optical disc recording medium and waveforms of a SUM signal, a SUM differential signal, and a P/P signal that are obtained at that time.

FIG. 20 is a diagram schematically illustrating a relationship between a clock generated from the SUM differential signal, waveforms of respective selector signals generated based on the clock, and (part of) respective pit lines formed on the reference surface.

FIG. 21 is a diagram for explaining a specific method for achieving spiral movement at an arbitrary pitch.

FIG. 22 is a diagram for mainly explaining a configuration of an optical system included in a recording-reproducing device of the third embodiment.

FIG. 23 is a diagram illustrating an internal configuration example of the entire recording-reproducing device of the third embodiment.

FIG. 24 is a diagram for explaining a first method in a fourth embodiment.

FIG. 25A is a diagram illustrating a state at a time when recording operation is performed by the first method.

FIG. 25B is a diagram illustrating a state at the time when recording operation is performed by the first method.

FIG. 26 is a diagram for mainly explaining a configuration of an optical system included in a recording-reproducing device for achieving a recording-reproducing operation by the first method.

FIG. 27 is a diagram illustrating an internal configuration example of the entire recording-reproducing device for achieving the recording-reproducing operation by the first method.

FIG. 28 is a diagram for explaining a second method of the fourth embodiment.

FIG. 29A is a diagram for explaining a specific recording operation (recording under a first tracking servo control mode) by the second method.

FIG. 29B is a diagram for explaining the specific recording operation (the recording under the first tracking servo control mode) by the second method.

FIG. 30A is a diagram for explaining a specific recording operation (recording under a second tracking servo control mode) by a second method.

FIG. 30B is a diagram for explaining the specific recording operation (the recording under the second tracking servo control mode) by the second method.

### MODES FOR CARRYING OUT THE INVENTION

Some embodiments according to the present technology will be described below.

It is to be noted that the description will be provided in the following order.

### [1. Summary of Tracking Error Detection Method in Embodiments]

### [1-1. Concerning Optical Limit Value]

### [1-2. Summary of Track Error Detection Method]

### [2. First Embodiment (Single Spiral Exposure Operation)]

### [2-1. Disc Manufacturing Process]

### [2-2. Configuration of Exposure Device]

### [2-3. Specific Exposure Method]

### [2-4. Configuration of Reproducing Device]

### [2-5. Tracking Servo Control Method]

### [3. Second Embodiment (Double Spiral Exposure Operation)]

### [3-1. Configuration of Exposure Device]

### [3-2. Configuration of Reproducing Device]

### [4. Third Embodiment (Single Spiral Recording for Recordable-type Disc)]

### [4-1. Structure of Optical Disc Recording Medium]

### [4-2. Position Control Method Utilizing Reference Surface]

### [4-3. Arbitrary Pitch Spiral Movement Control]

### [4-4. Configuration of Recording-Reproducing Device]

### [5. Fourth Embodiment (Method of Eliminating Necessity of Arbitrary Pitch Spiral Movement Control)]

### [5-1. First Method]

### [5-2. Configuration of Recording-Reproducing Device]

### [5-3. Second Method]

### [6. Modifications]

### 1. Summary of Tracking Error Detection Method in Embodiments

[1-1. Concerning Optical Limit Value]

First, before describing the embodiments, description will be provided of an optical limit value (optical cut-off) of a track pitch.

Hereinafter, a track formed of arranged pits or arranged marks in an optical disc recording medium is described as “track T”. Also, a formation spacing (a pitch) in a radial direction of the track T is described as “track pitch Tp”.

It is to be noted for conformation that the optical disc recording medium is a name collectively referring to disc-like recording media with which recording or reproducing of a signal is performed by light irradiation.

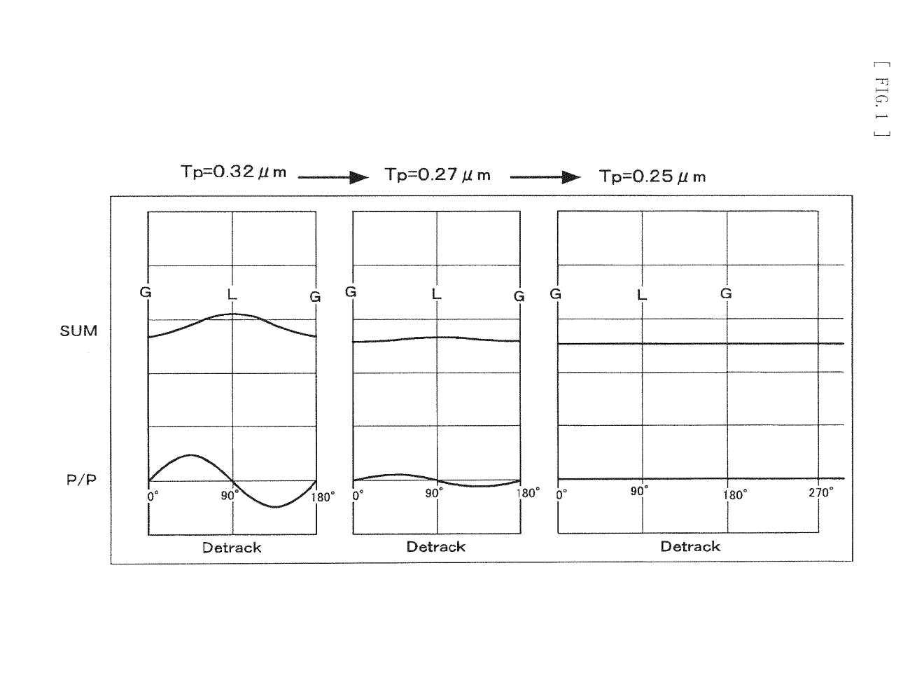

FIG. 1 illustrates a SUM signal (a low-range component signal of an RF signal) and a push-pull signal P/P that are observed in a case where the track pitch Tp is gradually reduced from 0.32 μm to 0.27 μm and to 0.23 μm.

It is to be noted that this drawing illustrates a result in a case where a recording-reproducing wavelength λ is set to be 405 nm, and a numerical aperture NA of an objective lens is set to be 0.85 as optical conditions similar to those in the current BD system (BD=Blur-ray Disc: registered trademark).

Further, the SUM signal and the push-pull signal P/P are assumed to be signals that are observed in a so-called traverse state (a state in which a laser spot crosses tracks in the radial direction). It is to be noted that, hereinafter, the push-pull signal P/P in the traverse state may be also described as “NPP signal”.

Further, a lateral axis indicates a detrack amount in a range from 0° to 360°. In the drawing, “G” represents a groove central position and “L” represents a land central position.

First, referring to the case where the track pitch Tp is 0.32 μm, it can be seen that signal modulation in accordance with groove/land being crossed at the time of traversing is appropriately observed in both the SUM signal and the push-pull signal P/P in this case. Based on the push-pull signal P/P in this case, it is understood that position information of the laser spot in the radial direction (a tracking direction: a radial direction), i.e., a tracking error signal is detectable.

On the other hand, when the track pitch Tp is reduced to 0.27 μm and to 0.23 μm, the modulation component is reduced in both the SUM signal and the push-pull signal P/P. It can be seen that no modulation component is observed in a case of 0.23 μm.

The track pitch Tp of 0.23 μm is a pitch shorter than an optical cut-off under the optical conditions of λ=405 nm and NA=0.85.

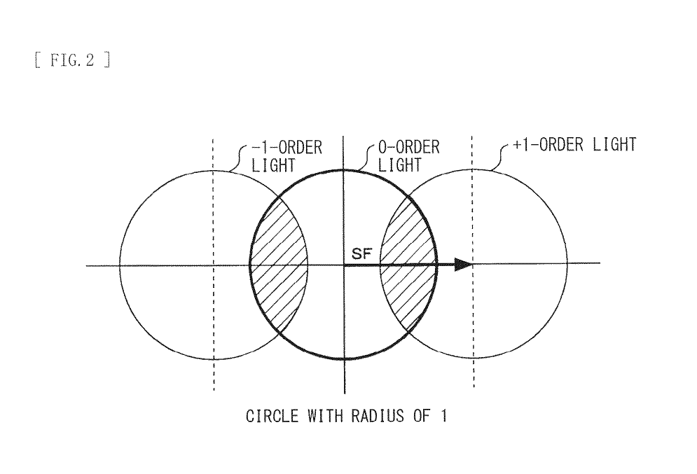

Description will be given of an optical cut-off referring to FIG. 2.

FIG. 2 illustrates 0-order light and diffracted light (+1-order light and −1-order light) of laser light. A shift amount of the diffracted light is shown as an arrow SF in the drawing.

A shift amount of the diffracted light in a case where a radius of a circle is set as “1” is expressed as follows.

Shift amount of diffracted light=λ/(NA·p)=(λ/NA)/p

It is to be noted that “p” is a cycle of a cycle structure. The cycle structure may be, for example, a cycle of a structure such as land/groove.

Concerning laser light (reflected light) that enters a photodetector, an overlapped portion of the 0-order light and ±1-order light is the modulation component.

Therefore, as an area of the overlapped portion shown as a shaded portion is larger, a difference between brightness and darkness is larger in detection by the photodetector. Therefore, a larger signal modulation is obtained.

In the case where the circle having a radius of “1” is set, when the shift amount of the diffracted light is “2”, no overlapped portion is present. Therefore, the modulation component is not allowed to be obtained.

In other words, when (λ/NA)/p=2 is established, the modulation signal is not obtained at all.

In the case of using the wavelength λ, the numerical aperture NA, etc. of the BD system, a cycle p of the cycle structure that allows the shift amount to be “2” is calculated as about 0.24 μm (0.238 μm).

Therefore, as a track pitch corresponding to the cycle p of the cycle structure, a pitch equivalent to the optical cut-off is about 0.24 μm.

The following is summary of the above.
When cycle p≦λ(2 NA) is established, no modulation signal is obtained.
When cycle p>λ(2 NA) is established, modulation signal is obtained.

As can be seen from the above, there is an optical limit in increasing density of recording by reducing track pitch.

Here, the limit value of about 0.24 μm derived as above is merely a theoretical value. The actual limit value is a value larger than 0.24 μm under influence of various degradation factors such as an optical noise.

Specifically, in the case of the BD system, the actual optical limit value, i.e., the limit value of the track pitch Tp that actually allows appropriate tracking servo operation is about 0.27 μm.

### [1-2. Summary of Track Error Detection Method]

In increasing density of recording by reducing track pitch as described above, the track pitch Tp of about 0.27 μm is the actual limit.

In the present embodiment, appropriate tracking servo operation is allowed to be performed even in a case where increase in density of recording is further pursued with the use of the track pitch Tp out of such an actual limit value. The issue of the present embodiment is to largely increase recording capacity in such a manner compared to that in the past.

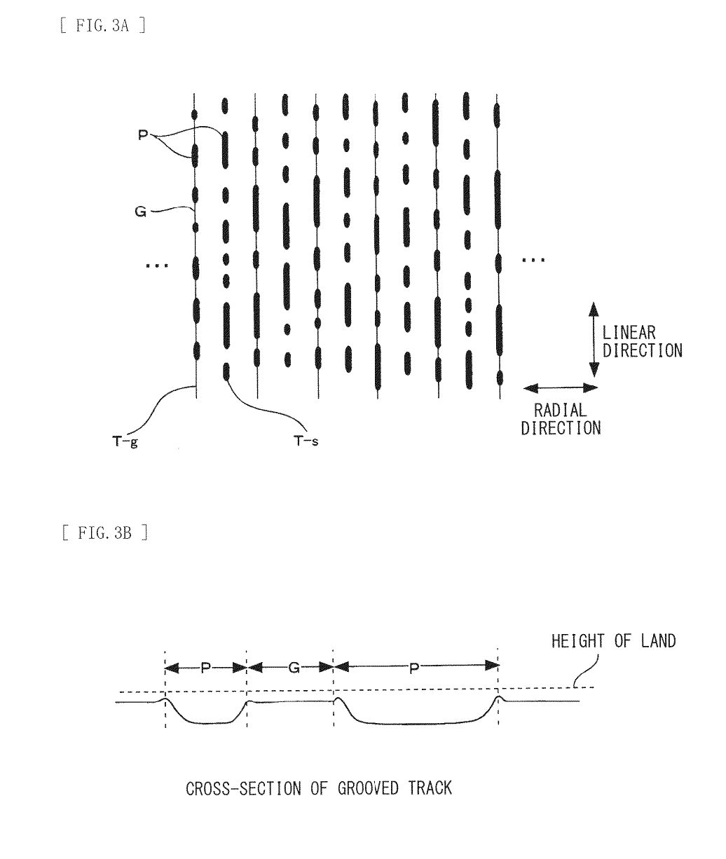

As a result of severe consideration for solving the above-described issue, the present inventors has found a method of forming the tracks T in the optical disc recording medium in a state shown in FIGS. 3A and 3B.

FIGS. 3A and 3B are diagrams for explaining a structure of the tracks T formed in the optical disc recording medium of the present embodiment. FIG. 3A shows a planar view, and FIG. 3B shows a cross-sectional view.

As shown in FIG. 3A, in the present embodiment, as the tracks T formed by arranging pits P in a linear direction, grooved tracks T-g and no-groove tracks T-s are arranged alternately in the radial direction. In the grooved track T-g, a groove G is inserted between the pits P. In the no-groove track T-s, no groove G is inserted between the pits P.

In this case, as shown in FIG. 3B, the groove G in the grooved track T-g is formed to have a depth that is deeper than a depth of a land and is shallower than a depth of the pit P.

In the present embodiment, the grooved tracks T-g and the no-groove tracks T-s are arranged alternately in such a manner, and further, the pitch of these tracks T is reduced to at least a value that is equal to or smaller than the actual optical limit value of 0.27 μm.

Specifically, in the case of the present example, the track pitch Tp is set to about 0.22 μm.

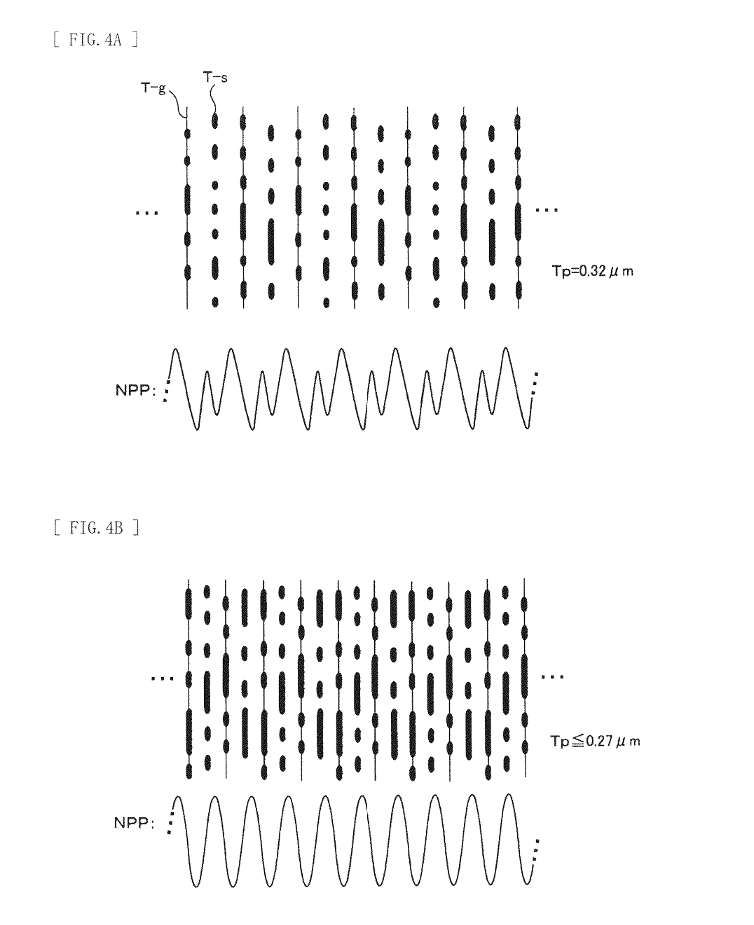

FIGS. 4A and 4B illustrate relationships in a case where the tracks T are formed in the arrangement shown in FIG. 3A. FIG. 4A illustrates a relationship between the respective tracks T and a NPP signal amplitude when the track pitch Tp is set to 0.32 μm. FIG. 4B illustrates a relationship between the respective tracks T and the NPP signal amplitude when the track pitch Tp is set to 0.27 μm or smaller.

It is to be noted that the optical conditions are λ=405 nm and NA=0.85 also in these drawings similarly to those of the BD system.

First, in the case of the track pitch Tp of 0.32 μm shown in FIG. 4A, it can be confirmed that an amplitude is obtained in correspondence with both the grooved tracks T-g and the no-groove tracks T-s as the NPP signal.

In this case, the obtained amplitude of the push-pull signal P/P is larger in the grooved tracks T-g than in the no-groove tracks T-s due to insertion of the grooves G.

Although it is not illustrated, when the track pitch Tp is reduced gradually from 0.32 μm, i.e., the track pitch Tp in the current BD system, an amplitude of a portion corresponding to the no-groove tracks T-s is attenuated gradually as the NPP signal.

Further, when the track pitch Tp is set to 0.27 μm or smaller which is out of the actual optical limit value, as shown in FIG. 4B, the amplitude of the portion corresponding to the no-groove tracks T-s is hardly obtained and an amplitude is obtained almost only in a portion corresponding to the grooved tracks T-g as the NPP signal. Accordingly, this means that an NPP signal almost similar to that in a case where only the grooved tracks T-g are formed on the optical disc recording medium is obtained. In other words, an NPP signal is obtained that is almost similar to that in a case where a track pitch twice as large as the track pitch Tp on the actual optical disc recording medium is set.

The tracking error signal amplitude is obtained only in correspondence with the grooved tracks T-g as described above. Therefore, tracking servo operation is allowed to be performed stably. Specifically, the tracking servo operation is allowed to be performed stably in the case where the tracks T are arranged at a pitch out of the optical limit value.

However, in this case, tracking servo operation is not allowed to be performed in different manners between the grooved tracks T-g and the no-groove tracks T-s by only simply performing servo control based on the tracking error signal. Specifically, both of the recorded information of the grooved tracks T-g and the recorded information of the no-groove tracks T-s are not allowed to be read appropriately.

Performing tracking servo operation in different manners between the no-groove tracks T-s and the grooved tracks T-g is achieved as follows.

Specifically, switching is performed between servo control based on a signal (a first control signal) obtained by inverting polarity of the tracking error signal and servo control based on a signal (a second control signal) in which polarity of the tracking error signal is not inverted in accordance with switching between at the time when the servo control is performed targeting the no-groove tracks T-s and at the time when the servo control is performed targeting the grooved tracks T-g.

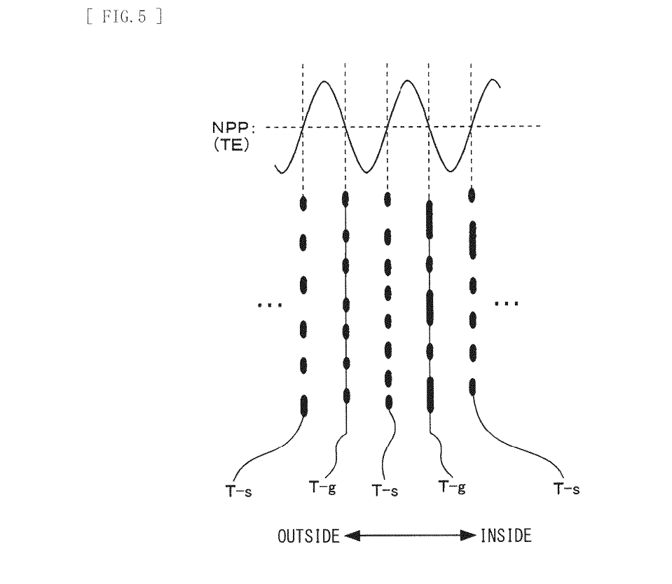

FIG. 5 is a diagram illustrating a more-detailed relationship between the NPP signal amplitude and the grooved tracks T-g and the no-groove tracks T-s.

It is to be noted that, in the drawing, the right side of the paper plane is set as the inner side and the left side of the paper plane is set as the outer side for the sake of description.

As shown in this drawing, the amplitude of the NPP signal becomes zero in both of the case where a beam spot of the laser light is located at the middle of the grooved track T-g and the case where the beam spot of the laser light is located at the middle of the no-groove tracks T-s.

It is to be noted that, concerning the grooved tracks T-g, for example, the value of the NPP signal varies from negative polarity to positive polarity when the beam spot traverses from the inner side to the outer side. On the other hand, concerning the no-groove tracks T-g, the value of the NPP signal varies from positive polarity to negative polarity in reverse when the beam spot traverses from the inner side to the outer side in a similar manner.

As can be seen by taking into consideration this relationship, when tracking servo operation is performed targeting the no-groove tracks T-s in which no groove G is formed, tracking servo control is performed based on a signal with inverted polarity as the tracking error signal.

Also, it goes without saying that, in this case, tracking servo control targeting the grooved tracks T-g in which the grooves G are formed is allowed to be performed based on the tracking signal itself (specifically, the tracking error signal on which no polarity inversion described above is performed).

Here, the above description refers to the example in which the signal obtained by inverting the polarity of the tracking error signal is used to perform tracking servo operation in different manners between the grooved tracks T-g and the no-groove tracks T-s. However, it goes without saying that such performing of the tracking servo operation in different manners is also achievable by using a signal obtained by providing, to the tracking error signal, an offset value (specifically, an offset value corresponding to a formation spacing of the grooved tracks T-g and the no-groove tracks T-s) corresponding to the track pitch Tp.

Specifically, the tracking servo control targeting the no-groove track T-s is performed based on a signal obtained by adding the above-described offset value to the tracking error signal. The tracing servo control targeting the grooved track T-g is performed based on the tracking error signal itself (specifically, the tracking error signal to which the above-described offset value is not added).

### 2. First Embodiment

### Single Spiral Exposure Operation

Based on the above-described assumption, respective embodiments according to the present technology will be described below.

Here, first, summary of the respective embodiments will be provided. First and second embodiments each propose a method to achieve manufacturing of a recording medium having a track structure as those shown in FIGS. 3A and 3B described above for a reproduction-only-type optical disc recording medium of a ROM (Read Only Memory) type.

Moreover, third and fourth embodiments each propose a method to perform recording so as to achieve the track structure as shown in FIGS. 3A and 3B for a recordable-type optical disk recording medium.

The first embodiment performs exposure operation in a single spiral fashion in manufacturing a ROM disc having the track structure as shown in FIGS. 3A and 3B.

[2-1. Disc Manufacturing Process]

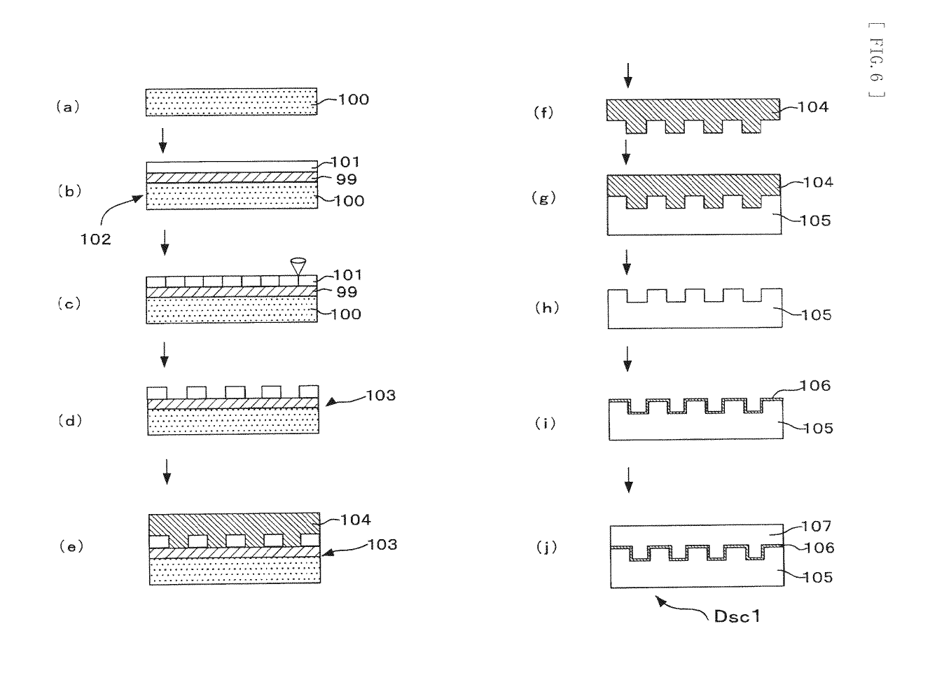

First, referring to FIG. 6, description will be provided of a manufacturing process of an optical disc recording medium (hereinafter, referred to as an optical disc Dsc1) in the first embodiment.

In FIG. 6, the processes of manufacturing the optical discs Dsc1 are roughly divided into a master manufacturing process, a recording process (an exposure process), a developing process, a mold (stamper) fabricating process, and a recording medium generating process.

Part (a) of FIG. 6 shows a master formation substrate 100 that configures an optical master disc (hereinafter, also described simply as “master disc” or “master”). First, an inorganic resist layer 101 made of an inorganic resist material is formed uniformly on this master formation substrate 100 by a method such as a sputtering method (the resist layer formation process, Part (b) of FIG. 6). Thus, an inorganic resist master 102 is formed first.

In this example, as a mastering process for manufacturing the master disc, mastering of a PTM (Phase Transition Mastering) method with use of an inorganic resist material is performed.

In this case, as a material provided for the resist layer 101, incomplete oxide of transition metal is used. As specific transition metal, for example, Ti, V, Cr, Mn, Fe, Nb, Cu, Ni, Co, Mo, Ta, W, Zr, Ru, Ag, etc. can be mentioned.

It is to be noted that, as a specific material of the resist layer 101, any material that achieves so-called thermal recording (any material which is allowed to be photosensitive by thermal reaction accompanying laser light irradiation) is allowed to be used without particular limitation.

Here, in order to improve exposure sensitivity of the inorganic resist layer 101, a predetermined intermediate layer 99 may be formed between the substrate 100 and the resist layer 101. Part (b) of FIG. 6 shows such a state. Anyway, it is enough that the resist layer 101 is formed to be exposed to the outside in an upper layer of the substrate 100 in order to be exposed to light in response to the laser light irradiation at the time of exposure operation.

Also, in this case, for example, a Si wafer substrate may be used as the master formation substrate 100, and the above-described resist layer 101 is formed by sputtering. In this case, DC or RF sputtering is used as the film formation method.

Next, selective exposure operation in accordance with the signal pattern is performed on the resist layer 101, and the resist layer 101 is allowed to be exposed (a resist layer exposure process, Part (c) of FIG. 6).

It is to be noted that this exposure process (recording process) is performed utilizing a master recording device 1 which will be described later.

Further, by developing the resist layer 101, a master disc 103 (hereinafter, also described as “developed master 103”) on which a predetermined concave-convex pattern is formed is formed (a resist layer developing process, Part (d) of FIG. 6). In this resist layer developing process, as a specific developing method, a method can be mentioned such as a dipping method using immersion and a method of applying chemical solution to the master 102 rotated by a spinner.

As a developer, for example, an organic alkali developer such as TMAH (tetramethylammonium hydroxide), an inorganic alkali developer such as KOH, NaOH, and a phosphate-based developer, etc. may be used.

Subsequently, the developed master 103 formed as described above is washed with water. Thereafter, a metal master is fabricated in an electroforming bath (an electroforming process, Part (e) of FIG. 6). Further, after this electroforming, the developed master 103 is peeled off from the metal master. Thus, a stamper 104 for molding is obtained on which the concave-convex pattern of the developed master 103 is transferred (Part (f) of FIG. 6). In this case, Ni is used as a material of the above-described metal master (the stamper 104).

Here, before performing the electroforming process in Part (e) of FIG. 6, it is possible to improve demolding characteristics by performing a demolding process on a surface of the developed master 103. This can be performed as necessary.

The improvement of the demolding characteristics may be performed, for example, by performing any process described below on the developed master 103.

1) immerse the developed master 103 in alkali solution heated to 40° C. to 60° C. for several minutes.

2) electrolytically oxidize the developed master 103 while immersing the developed master 103 in electrolytic alkali solution heated to 40° C. to 60° C. for several minutes.

3) form an oxidized film by RIE, etc.

4) form a metal oxide film with the use of a film forming device.

Alternatively, improvement of the demolding characteristics may be achieved also by selecting, in advance, a material that has a composition with an oxygen composition ratio that achieves easier demolding from the metal master, as the inorganic resist material.

It is to be noted that, after fabricating the stamper 104, the developed master 103 is stored in a dried state after washing with water. Thus, the desirable number of stampers 104 are fabricated repeatedly as necessary.

Subsequently, a resin disc substrate 105 made of thermoplastic resin (such as polycarbonate) is formed by an injection molding method with the use of the stamper 104 (Part (g) of FIG. 6).

Thereafter, the stamper 104 is peeled off (Part (h) of FIG. 6), and a reflection film 106 made of a material such as Ag alloy (Part (i) of FIG. 6) and a protective film 107 having a thickness of about 0.1 mm are formed on the concave-convex surface of the resin disc substrate 105. Thus, the optical disc Dsc1 is formed (Part (j) of FIG. 6). Consequently, an optical disc recording medium in which information is stored by the formation pattern of pits is obtained.

[2-2. Configuration of Exposure Device]

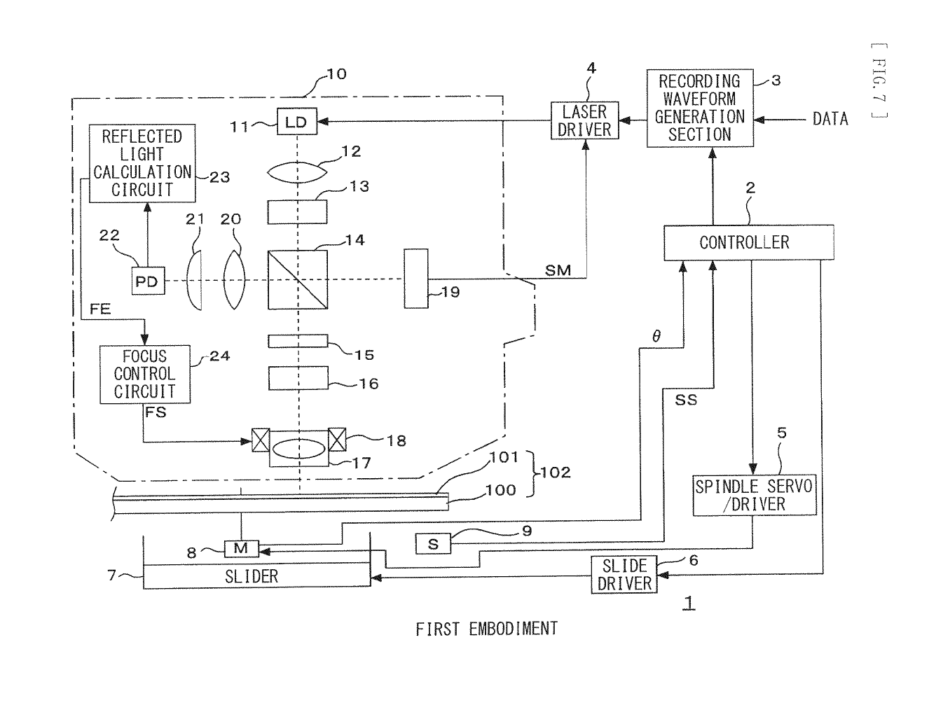

FIG. 7 shows an internal configuration example of the master recording device 1.

The master recording device 1 of the present example forms, in the mastering process shown in Part (c) of FIG. 6, a recording mark by performing a thermal recording operation by irradiating laser light to the master 102 before recording on which the inorganic resist layer 101 is formed.

In FIG. 7, the master recording device 1 includes a configuration shown by a dashed-dotted line as a pick-up head 10. In the pick-up head 10, a laser light source 11 as a semiconductor laser has a wavelength set in accordance with a type of an optical disc recording medium to be manufactured. In the case of the present example, a wavelength of about 405 nm in accordance with the BD is assumed to be set.

Laser light emitted from the laser light source 11 is allowed to be parallel light by the collimator lens 12. Thereafter, a spot shape of the parallelized laser light may be deformed, for example, into a circular shape by an anamorphic prism 13, and then, is guided to a polarizing beam splitter (PBS) 14.

The polarized light component that has passed through the polarizing beam splitter 14 is guided to an objective lens 17 via a ¼ wavelength plate 15 and a beam expander 16, and condensed by the objective lens 17 to be irradiated on the inorganic resist master 102.

The laser light irradiated to the master 102 via the objective lens 17 as described above is focused on the inorganic resist layer 101 in the master 102. The inorganic resist layer 101 absorbs the laser beam, and thereby, in particular, a portion heated to a high temperature around the center of the irradiation section is polycrystallized.

Due to this function, an exposure pattern is formed on the inorganic resist layer 101.

The laser light reflected by the polarizing beam splitter 14 is irradiated to a monitor detector 19 (a photodetector for laser power monitor). The monitor detector 19 outputs a light intensity monitor signal SM in accordance with an amount of received laser light (light intensity).

On the other hand, returned light of the laser light irradiated to the inorganic resist master 102 passes through the objective lens 17, the beam expander 16, and the ¼ wavelength plate 15 and reaches the polarizing beam splitter 14.

Here, the returned light of the laser light reaching the polarizing beam splitter 14 in such a manner passes through the ¼ wavelength plate 15 twice for an outward path and a returning path. Therefore, a polarization direction of such returned light is rotated by 90°, and therefore, the returned light is reflected by the polarizing beam splitter 14. The returned light reflected by the polarizing beam splitter 14 is received by a light receiving surface of a photodetector 22 via a condensing lens 20 and a cylindrical lens 21.

The light receiving surface of the photodetector 22 may have, for example, a light receiving surface segmented into four, and is configured to be allowed to obtain a focus error signal based on astigmatism.

Each light receiving surface of the photodetector 22 outputs a current signal in accordance with the amount of received light, and supplies the outputted current signal to a reflected light calculation circuit 23.

The reflected light calculation circuit 23 converts the current signal supplied from each of the four-segmented light receiving surfaces into a voltage signal, and performs a calculation process as an astigmatism method to generate a focus error signal FE.

As shown in the drawing, the focus error signal FE is supplied to a focus control circuit 24.

The focus control circuit 24 generates, based on the focus error signal FE, a servo drive signal FS of an actuator 18 that holds the objective lens 17 in a manner that allows the objective lens 17 to travel in a focusing direction. Further, the actuator 18 drives, based on the servo drive signal FS, the objective lens 17 in a direction toward or away from the inorganic resist master 102. Thus, focus servo operation is performed.

The inorganic resist master 102 is driven to rotate by a spindle motor 8. The spindle motor 8 is driven to rotate while rotation speed thereof is controlled by a spindle servo/driver 5. Thus, the inorganic resist master 102 may be rotated, for example, at a constant linear velocity.

Moreover, in the case of the present example, the spindle motor 8 detects a rotation angle (θ) of the inorganic resist master 102. Information on the rotation angle θ detected by the spindle motor 8 is supplied to a controller 2 which will be described later.

A slider 7 is driven by a slide driver 6. The slider 7 allows a base as a whole, which includes a spindle mechanism and on which the inorganic resist master 102 is mounted, to move. Specifically, the inorganic resist master 102 in a state rotated by the spindle motor 8 is allowed to be exposed by the above-described optical system while being moved in the radial direction by the slider 7. Thus, groove portions (pit lines: tracks T) formed in the inorganic resist layer 101 are formed in a spiral fashion.

A position of the movement of the slider 7, i.e., an exposure position of the inorganic resist master 102 (a disc radius position: a slider radius position) is detected by a sensor 9. Position detection information SS detected by the sensor 9 is supplied to the controller 2.

The controller 2 may be configured, for example, of a microcomputer. The controller 2 may perform general control of the master recording device 1. For example, the controller 2 may perform control of spindle rotation operation of the spindle servo/driver 5, control of movement operation of the slider 7 by the slide driver 6, etc., and thereby controls the recording position on the master 102.

Moreover, in the case of the present example in particular, the controller 2 performs recording control based on the information of the rotation angle θ detected by the spindle motor 8, which will be described later.

Here, in the present embodiment, the track pitch Tp is set to a predetermined pitch (in the present example, about 0.22 μm as described above) of 0.27 μm or smaller. The controller 2 performs control of the slide driver 6 so that such a predetermined pitch be achieved.

A recording waveform generation section 3 performs a predetermined recording modulation coding process on input data to obtained a recording modulation code string. The recording waveform generation section 3 also generates a recording waveform in accordance with the obtained recording modulation code string based on a write strategy setting instructed by the controller 2.

The laser driver 4 inputs a recording waveform (a recording drive signal) generated by the recording waveform generation section 3, and drives the laser light source 11 in the pick-up head 10. The laser driver 4 supplies a light emission drive current in accordance with the above-described recording drive signal to the laser light source 11.

It is to be noted that, the light intensity monitor signal SM is also supplied from the monitor detector 19 to the laser driver 4. The laser driver 4 is allowed to also perform control of laser light emission based on a result obtained by comparing this light intensity monitor signal SM with a reference value.

[2-3. Specific Exposure Method]

Here, as described above, the first embodiment achieves the track structure as shown in FIGS. 3A and 3B by performing exposure operation in a single spiral fashion.

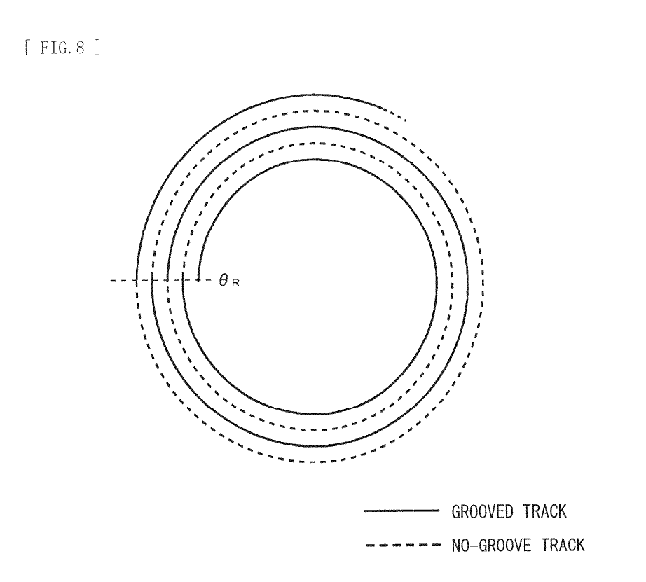

In this case, in order to achieve alternate arrangement of the grooved tracks T-g and the no-groove tracks T-s as shown in FIG. 3A with the use of one laser beam emitted from the laser light source 11, switching between recording of the grooved tracks T-g and recording of the no-groove tracks T-s may be performed at a certain rotation angle (a rotation angle θ_{R} in the drawing) as shown in FIG. 8.

Therefore, in the first embodiment, such switching of recording operation at the rotation angle θ_{R} is performed by the control by the controller 2.

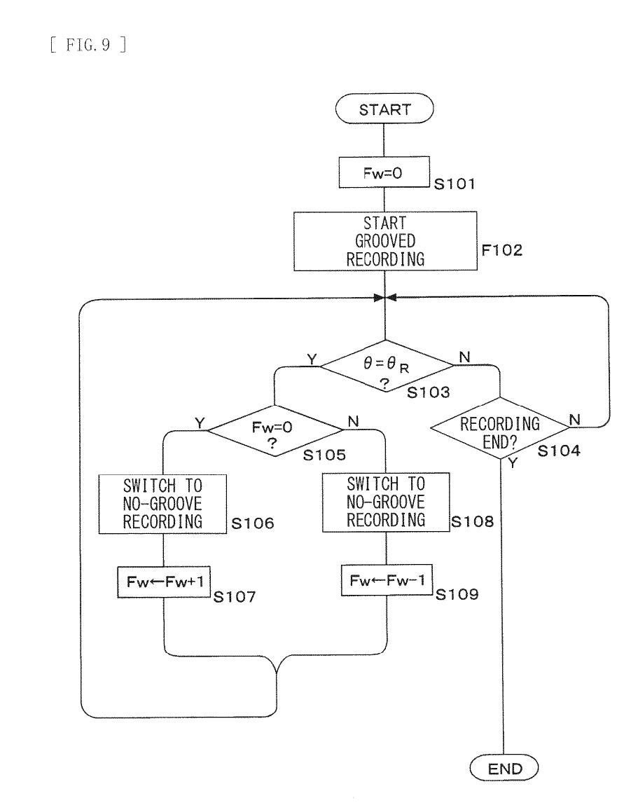

FIG. 9 is a flowchart showing procedure of specific processes to be executed in order to achieve a method of switching of recording operation as shown in FIG. 8.

It is to be noted that the processes shown in FIG. 9 are to be executed by the controller 2 shown in FIG. 7, for example, based on a program stored in a built-in ROM, etc.

In FIG. 9, in step S101, a recording operation identifier Fw is reset to 0.

It is to be noted that, as will be clearly described later, the recording operation identifier Fw becomes an identifier for identifying whether the current recording operation is a recording operation for the grooved tracks T-g (hereinafter, also described as “grooved recording operation”) or a recording operation for the no-groove tracks T-s (also described as “no-groove recording operation”). In the case of the present example, F=0 represents the grooved recording operation, and F=1 represents the no-groove recording operation.

After resetting the identifier Fw to 0, in step S102, a process for starting the grooved recording operation is performed. Specifically, an instruction is provided to the recording waveform generation section 3, and control is performed to allow a pit line based on the input data to be formed in a form of the grooved track T-g.

In this case, recording operation of the groove G formed between the pits P is performed with power lower than that for the formation portion of the pit P so that the depth shown in FIG. 3B described above be achieved in the groove G to be formed between the pits P.

After starting the grooved recording operation in step S102, it is waited until there is achieved a state in which the rotation angle θ=θ_{R} is established or a state in which recording operation is to be ended is established by the processes in steps S103 and S104 in the drawing.

Specifically, in the step S103, it is determined whether or not the value of the rotation angle θ detected by the spindle motor 8 becomes the angle θ_{R} which has been determined in advance. In a case where a negative result is obtained that shows the value of the rotation angle θ is determined not to be θ_{R}, the process proceeds to step S104 and it is determined whether or not a state in which the recording operation is to be ended is achieved. Further, in the step S104, in a case where a negative result is obtained that shows that the state in which the recoding operation is to be ended is not achieved, the process returns to step S103.

In step S103, in a case where a positive result is obtained that shows that the rotation angle θ=θ_{R} is established, the process proceeds to step S105, and it is determined whether or not F=0 is established.

In step S105, in a case where a positive result is obtained that shows F=0 is established (specifically, a state under grooved recording operation is achieved), the process proceeds to step S106, and a process for performing switching to the no-groove recording operation is performed. Specifically, an instruction is provided to the recording waveform generation section 3, and control is performed so that the pit line based on the input data is formed in a form of the no-groove track T-s.

Further, in subsequent step S107, the value of the recording operation identifier Fw is set as F←F+1 (F=1). Thereafter, the process returns to step S103 described above.

On the other hand, in a case where a negative result is obtained that shows F=0 is not established (specifically, a state under no-groove recording operation is achieved) in the above-described step S105, the process proceeds to step S108, and a process for performing switching to the grooved recording operation is performed. Further, in subsequent step S109, the value of the recording operation identifier Fw is set as F←F−1 (F=0), and then, the process returns to step S103 described above.

Moreover, in a case where a positive result is obtained that shows a state in which the recording operation is to be ended is achieved, in step S104 described above, the process operation shown in this drawing is ended.

Due to the above-described series of processes, it is possible to perform switching between the grooved recording operation and the no-groove recording operation every time the rotation angle θ of the inorganic resist master 102 becomes the predetermined rotation angle θ_{R}.

In other words, it is possible to achieve, as the optical disc Dsc1 formed based on the inorganic resist master 102, an optical disc recording medium in which the grooved tracks T-g and the no-groove tracks T-s are formed alternately in the radial direction at a pitch of 0.27 μm or smaller as shown in FIG. 3A described above.

[2-4. Configuration of Reproducing Device]

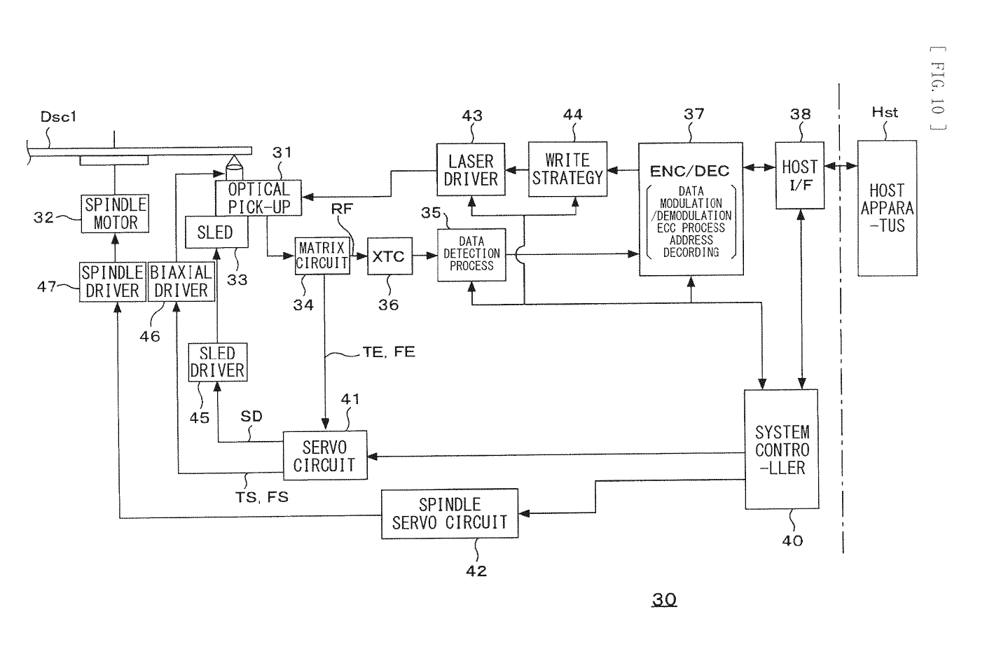

FIG. 10 is a diagram illustrating an internal configuration example of a disc drive device 30 that performs reproducing operation of the optical disc Dsc1 of the first embodiment.

It is to be noted that, in this drawing, there is exemplified a configuration of a disc drive device provided with a recording function for a recordable-type optical disc other than the reproducing function for the optical disc Dsc1 which is a ROM disc. However, as the disc drive device 30 of the present example, a configuration related to achievement of the recording function may be omitted.

In FIG. 10, the optical disc Dsc1 (or a recordable-type optical disc) is loaded in the disc drive device and is mounted on a turn table which is not illustrated. Such an optical disc Dsc1 (or the recordable-type optical disc) is driven by a spindle motor 32 to rotate at a constant linear velocity (CLV) or at a constant angular velocity (CAV) at the time of recording/reproducing operation.

Further, at the time of reproducing operation, information recorded in the information recording track on the optical disc Dsc1 is read by an optical pick-up (an optical head) 31.

Moreover, at the time of data recording operation with respect to the recordable-type optical disc, user data is recorded by the optical pick-up 31 as a mark line in the track on that optical disc.

In the optical pick-up 31, there are formed a laser diode to serve as a laser light source, a photodetector for detecting reflected light, an objective lens to serve as an output terminal of the laser light, an optical system that irradiates the laser light to the disc recording surface via the objective lens and guides the reflected light to the photodetector, etc.

In the optical pick-up 31, the above-described objective lens is held by a biaxial actuator in a manner that allows the objective lens to travel in a tracking direction and a focusing direction.

Moreover, the optical pick-up 31 as a whole is allowed to move in the radial direction of the disc by a sled mechanism 33.

Moreover, the above-described laser diode in the optical pick-up 31 is driven to emit laser light by application of a drive current by a laser driver 43.

Information of the reflected light from the optical disc is detected by a photodetector. The detected information is converted into an electric signal in accordance with the amount of the received light, and the electric signal is supplied to a matrix circuit 34.

The matrix circuit 34 includes a current-voltage conversion circuit, a matrix calculation/amplification circuit, etc. in accordance with the output current from a plurality of light receiving elements serving as photodetectors. The matrix circuit 34 generates a necessary signal by performing a matrix calculation process.

For example, the matrix circuit 34 may generate signals such as a reproduction information signal (hereinafter, described as “RF signal”) corresponding to reproduction data, a focus error signal FE for servo control, and a tracking error signal TE.

The RF signal outputted from the matrix circuit 34 is supplied to a data detection process section 35 via a cross-talk cancel circuit (XTC) 36.

Moreover, the focus error signal FE and the tracking error signal TE outputted from the matrix circuit 34 are supplied to a servo circuit 41.

The cross-talk cancel circuit 36 performs a cross-talk cancel process on the RF signal.

Here, the optical disc Dsc1 of the present embodiment has tracks T that are adjacent to one another at the track pitch Tp that is extremely small and out of the optical limit value as described above with FIGS. 3A, 3B, etc. As the track pitch Tp is smaller, more cross-talk components of the adjacent track are mixed at the time of reproducing operation. Therefore, the cross-talk cancel circuit 36 is provided, and a process of cancelling the RF signal component of the adjacent track is performed.

It is to be noted that the technology of the cross-talk cancel process for the RF signal is a well-known technology as disclosed, for example, in the respective referential literatures below. Therefore, detailed description thereof is omitted herein.

It is to be noted that a method that is considered as optimum is allowed to be selected appropriately as a specific method for the cross-talk cancel process other than the well-known technologies disclosed in the following referential literatures.

Referential Literature 1: Specification of Japanese Patent No. 3225611

Referential Literature 2: Specification of Japanese Patent No. 2601174

Referential Literature 3: Specification of Japanese Patent No. 4184585

Referential Literature 4: Japanese Unexamined Patent Application Publication No. 2008-108325

A data detection process section 35 performs binarization process on the RF signal.

For example, the data detection process section 35 may perform processes such as an A/D conversion process on the RF signal, a reproduction clock generation process by PLL (Phase Locked Loop), a PR (Partial Response) equalization process, and Viterbi decoding (maximum likelihood decoding), and obtains binary data string by a partial response maximum likelihood decoding process (PRML detection method: Partial Response Maximum Likelihood detection method).

Further, the data detection process section 35 supplies, to an encoding/decoding section 37 in a later stage, the binary data string as the information read from the optical disc Dsc1.

The encoding/decoding section 37 performs decoding process of the reproduction data at the time of reproducing operation, and performs a modulation process on the recorded data at the time of recording operation. Specifically, the encoding/decoding section 37 performs processes such as data decoding, deinterleaving, ECC decoding, and address decoding at the time of reproducing operation, and performs processes such as ECC encoding, interleaving, and data modulation at the time of recording operation on the recordable-type optical disc.

At the time of reproducing operation, the binary data string decoded by the data detection process section 35 is supplied to the encoding/decoding section 37. The encoding/decoding section 37 performs a decoding process on the above-described binary data string, and thereby, reproduction data is obtained.

For example, when the data recorded in the optical disc Dsc1 has been subjected to run length limited code modulation (RLL; Run Length Limited, PP: Parity preserve/Prohibit rmtr (repeated minimum transition runlength)) such as RLL(1, 7) PP modulation, a decoding process with respect to such data modulation is performed, and also, an error is corrected by an ECC decoding process. Thus, the reproduction data is obtained.

The data decoded into the reproduction data by the encoding/decoding section 37 is transferred to a host interface 38, and is transferred to a host apparatus Hst based on an instruction by a system controller 40. The host apparatus Hst may be, for example, a computer apparatus, an AV (Audio-Visual) system apparatus, etc.

Moreover, at the time of recording operation, the recorded data is transferred from the host apparatus Hst. The transferred recorded data is supplied to the encoding/decoding section 37 via the host interface 38.

The encoding/decoding section 37 in this case performs, as an encoding process of the recorded data, processes such as an error correction code attachment (ECC encoding), interleaving, and sub-code attachment. Also, on the data subjected to these processes, the encoding/decoding section 37 may perform, for example, run length limited code modulation such as that of the RLL(1-7)PP method, etc.

The recorded data that has been processed by the encoding/decoding section 37 is supplied to a write strategy section 44. The write strategy section performs, as a recording compensation process, adjustment of a laser driving pulse waveform with respect to, for example, characteristics of the recording layer, a shape of the spot of the laser light, and recording linear velocity. Further, the write strategy section 44 outputs the laser driving pulse to the laser driver 43.

The laser driver 43 applies a current to a laser diode in the optical pick-up 31 to allow the laser light emission driving to be executed, based on the laser driving pulse that has been subjected to the recording compensation process. Thus, a mark in accordance with the recorded data is formed in the recordable-type optical disc.

It is to be noted that the laser driver 43 includes a so-called APC (Auto Power Control) circuit. The laser driver 43 performs control to allow the output of the laser to be constant independent from temperature etc. while monitoring the laser output power with the use of the output of the detector for monitoring laser power provided in the optical pick-up 31.

A target value of the laser output at the time of recording and reproducing is provided by the system controller 40. The control is performed to allow the laser output level at each time of recording operation and reproducing operation to be the target value.

The servo circuit 41 generates various signals such as the focus servo signal FS, the tracking servo signal TS, and the sled drive signal SD based on the focus error signal FE and the tracking error signal TE from the matrix circuit 34, and thereby allows a servo operation to be executed.

Specifically, the focus servo operation is achieved by generating the focus servo signal FS by performing a filter process for generating servo signal on the focus error signal FE, and by driving a focusing coil of the biaxial actuator in the optical pick-up 31 by the biaxial driver 48 based on the focus servo signal FS.

Also, concerning the sled servo operation, the sled drive signal SD is generated based on the sled error signal obtained as a low range component of the tracking error signal TE, based on access execution control by the system controller 40, etc., and the sled mechanism 33 is driven by the sled driver 49. The sled mechanism 33 includes a mechanism configured of a component such as a main shaft holding the optical pick-up 31, a sled motor, and a transfer gear. A desirable slide movement of the optical pick-up 31 is performed by driving the above-described sled motor in accordance with the sled drive signal SD.

Also, the servo circuit 41 achieves the tracking servo control (performing tracking servo operation in different manners between the grooved track T-g and the no-groove track T-s) as the above-described embodiment based on the tracking error signal TE and the instruction from the system controller 40, which will be described later in detail.

A spindle servo circuit 42 performs control to allow the spindle motor 32 to perform CLV (constant linear velocity) rotation.

The spindle servo circuit 42 may obtain, for example, a clock generated by the PLL process on the RF signal as current rotation velocity information of the spindle motor 32, and compares the obtained clock with predetermined CLV reference velocity information. Thus, the spindle servo circuit 42 generates a spindle error signal.

Further, the spindle servo circuit 42 outputs a spindle drive signal generated in accordance with the spindle error signal, and allows the spindle driver 47 to execute the CLV rotation of the spindle motor 32.

Further, the spindle servo circuit 42 generates a spindle drive signal in accordance with a spindle kick/break control signal from the system controller 40, and thereby to allow an operation such as starting, stopping, acceleration, and deceleration of the spindle motor 32 to be executed as well.

Various operations of the servo system and the recording-reproducing system as described above are controlled by the system controller 40 formed of a microcomputer.

The system controller 40 executes various processes in accordance with the command from the host apparatus Hst provided via the host interface 38.

For example, when the host apparatus Hst provides a write command, the system controller 40 first allows the optical pick-up 31 to move to a logical or physical address to be written in. Further, the system controller 40 allows the encoding/decoding section 37 to execute the encoding process as described above on the data (such as video data and audio data) transferred from the host apparatus Hst. Further, the laser driver 43 performs laser light emission drive as described above in accordance with the encoded data, and thereby, recording operation is executed.

Alternatively, when a read command that requires to transfer certain data recorded in the optical disc Dsc1 is supplied from the host apparatus Hst, the system controller 40 first performs seek operation control targeting the instructed address. Specifically, the system controller 40 instructs the servo circuit 41 to execute an access operation of the optical pick-up 31 targeting the address designated by the seek command.

Thereafter, the system controller 40 performs operation control necessary for transferring the data in the instructed data section to the host apparatus Hst. Specifically, data reading from the optical disc Dsc1 is allowed to be executed, the reproduction processes in the data detection process section 35 and the encoding/decoding section 37 are executed, and required data is transferred.

Moreover, particularly in the case of the present embodiment, the system controller 40 also performs a process to achieve performing of the tracking servo operation in different manners described above based on the result of determination of whether or not the rotation angle θ of the optical disc Dsc1 is the particular rotation angle θ_{R} (this process will be described later).

It is to be noted that the present example in FIG. 10 has been described as a disc drive device connected to the host apparatus Hst. However, the disc drive device 30 may have a form not being connected to other apparatus. In that case, an operation section, a display section, etc. may be provided, and the configuration of the interface part for input and output of data may be different from the configuration shown in FIG. 10. In other words, recording operation, reproducing operation, etc. may be performed in accordance with the operation of a user, and a terminal section for inputting and outputting various data may be formed. It goes without saying that various configuration examples may be achievable other than this example as the configuration example of the disc drive device 30.

[2-5. Tracking Servo Control Method]

Here, it is assumed that, in order to achieve performing of the tracking servo operation in different manners described above, a predetermined pattern as marker information is recorded in a position at the rotation angle θ_{R} on each track T, as recorded information for the optical disc Dsc1, in the optical disc Dsc1 of the present embodiment.

It is to be noted that the recording operation of such marker information representing the rotation angle θ_{R} be may achieved, for example, by instructing insertion of a recording pattern as the marker to the recording waveform generation section 3 by the controller 2 every time the rotation angle θ_{R} is achieved in the master recording device 1 shown in FIG. 7.

The system controller 40 may input, for example, the binary data string obtained in the data detection process section 35, and thereby, detects the information as the above-described marker.

Further, in response to the detection of the marker information, the system controller 40 instructs, to the servo circuit 41, switching of tracking servo operation.

Here, as described above, as the method of performing tracking servo operation in different manners, two types of methods can be mentioned. That is, a method of using a signal obtained by inverting a polarity of the tracking error signal TE, and a method of providing offset corresponding to the track pitch Tp to the tracking error signal TE.

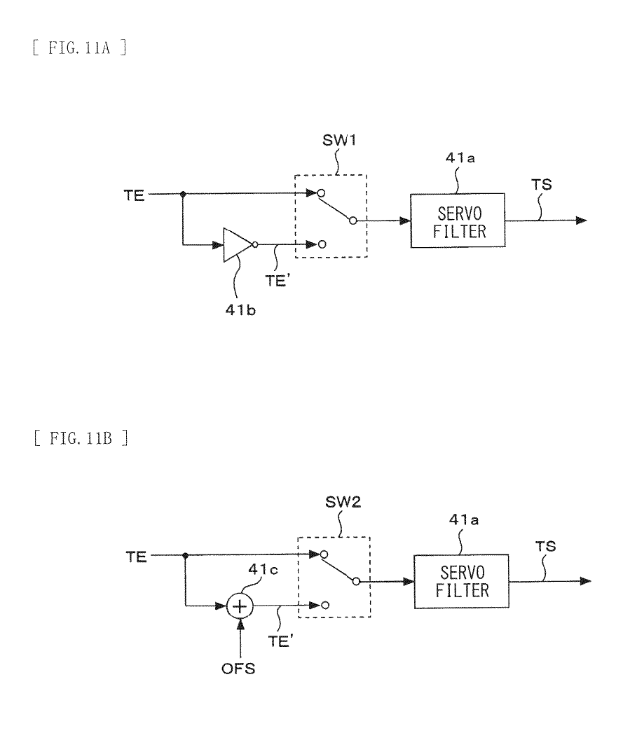

FIGS. 11A and 11B each show, as an example, an internal configuration of the servo circuit 41 in cases in correspondence with these methods.

FIG. 11A shows an example of the internal configuration of the servo circuit 41 in correspondence with a case where the method using the polarity-inverted signal is adopted. FIG. 11B shows an example of the internal configuration of the servo circuit 41 in correspondence with a case where the method providing the offset is adopted.

It is to be noted that these drawings extract and show only the configuration related to tracking servo control in the servo circuit 41.

In the case shown in FIG. 11A, it is assumed that the servo circuit 41 obtains the tracking error signal TE itself and a signal (hereinafter, described as “tracking error signal TE”) obtained by inverting the polarity of the tracking error signal TE by a inverting circuit 41b. The servo circuit 41 is configured to selectively output one of these signals to a servo filter 41a with the use of a switch SW1.

On the other hand, in the case shown in FIG. 11B, it is assumed that the servo circuit 41 obtains the tracking error signal TE itself and a signal (similarly, described as “tracking error signal TE′”) obtained by adding a predetermined offset value OFS to the tracking error signal TE by an adder 41c. The servo circuit 41 is configured to selectively output one of these signals to the servo filter 41a with the use of a switch SW2.

Here, as can be understood from the above description, the offset value OFS is set to a value corresponding to the track pitch Tp in the optical disc Dsc1. In other words, the offset value OFS is selected so that, when tracking servo control is performed with the use of the tracking error signal TE′ obtained by adding the offset value OFS, the beam spot position of the laser light become in a position away from the grooved track T-g by one track.

Such a configuration is adopted for the servo circuit 41, and the system controller 40 achieves performing tracking servo operation in different manners as described above by executing the following processes.

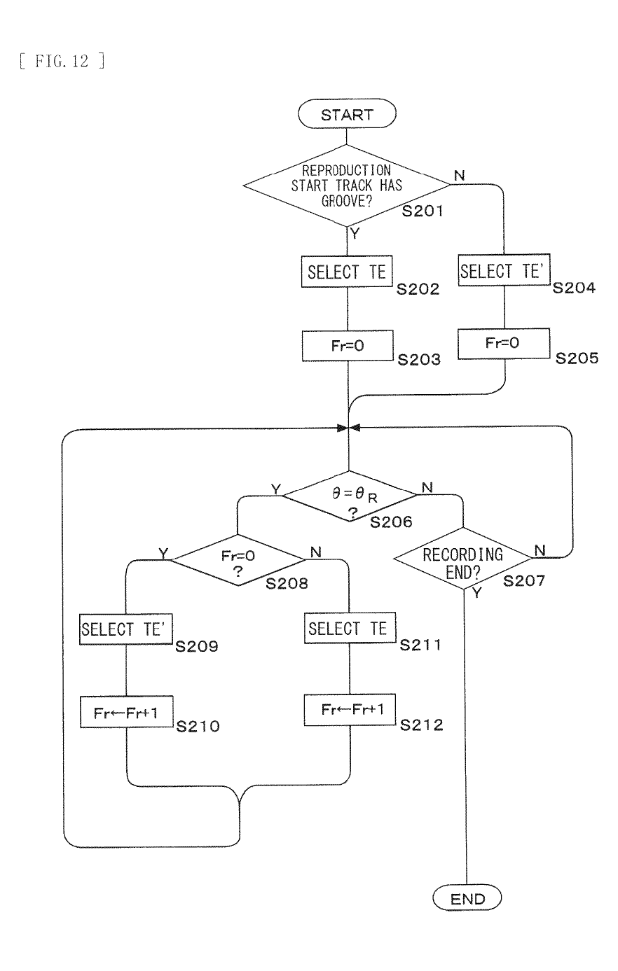

FIG. 12 is a flowchart showing a procedure of specific processes to be executed in order to achieve performing the tracking servo operation in different manners between the grooved track T-g and the no-groove track T-s.

It is to be noted that the processes shown in FIG. 12 are executed by the system controller 40, for example, based on a program stored in a built-in ROM, etc.

In FIG. 12, first in step S201, it is determined whether or not a reproduction start track is the grooved track. Specifically, it is determined whether or not a reproduction start position instructed by the read command from the host apparatus Hst is on the grooved track T-g.

In step S201, when a positive result is obtained showing the reproduction start track is the grooved track, the procedure proceeds to step S202, and a process for selecting the tracking error signal TE is performed. Specifically, by instructing the servo circuit 41 to select a terminal of the switch SW1 or the switch SW2, the tracking error signal TE is allowed to be input to the servo filter 41a.

Further, after allowing the tracking error signal TE to be selected in step S202, in step S203, a process of setting a reproducing operation identifier Fr to 0 is performed. Here, the reproducing operation identifier Fr is a value for identifying, as a current reproducing operation, a state (Fr=0) in which reproducing operation of the grooved track T-g is performed and a state (Fr=1) in which reproducing operation of the no-groove track T-s is performed.

After setting the identifier Fr in step S203, the procedure proceeds to step S206.

On the other hand, when a negative result is obtained showing that the reproduction start track is not the grooved track, the procedure proceeds to step S204, and a process for selecting the tracking error signal TE′ is performed. Specifically, by instructing the servo circuit 41 to select a terminal of the switch SW1 or the switch SW2, the tracking error signal TE′ (the polarity-inverted signal or offset-OFT-added signal) is allowed to be inputted to the servo filter 41a.

Further, after allowing the tracking error signal TE′ to be selected in step S204, in step S205, a process of setting the reproducing operation identifier Fr to 1 is performed. After setting the identifier Fr in step S205, the procedure proceeds to step S206.

Depending on step S206 and step S207, it is made to stand by until one of a state where the rotation angle θ=θ_{R} is established or a state where reproducing operation is to be ended is established.

Specifically, in step S206, it is determined whether or not the rotation angle θ=θ_{R} is established. Specifically, in the case of the present example, it is determined whether or not the marker information is detected, for example, based on the binary data string from the data detection process section 35 as described above.

Further, in step S206, when a negative result is obtained showing that the marker information is not detected and the rotation angle θ=θ_{R} is not established, the procedure proceeds to step S207, and it is determined whether or not the state where reproducing operation is to be ended is established. When a negative result is obtained in step S207, the procedure returns to step S206.

In this case, when the marker information is detected and the positive result is obtained showing that the rotation angle θ=θ_{R} is established in step S206, the procedure proceeds to step S208 in response thereto, and it is determined whether or not the reproduction operation identifier Fr=0 is established.

When a positive result is obtained showing that the identifier Fr=0 is established (in other words, the grooved track T-g is being reproduced) in step S208, the procedure proceeds to step S209, and a process for selecting the tracking error signal TE′ is performed. Further, in subsequent step S210, Fr=1 is set by establishing the identifier Fr←Fr+1. Thereafter, the procedure returns to step S206 described above.

On the other hand, when a negative result is obtained showing that the identifier Fr=0 is not established (in other words, the no-groove track T-s is being reproduced) in step S208, the procedure proceeds to step S211, and a process for selecting the tracking error signal TE is performed. Further, in subsequent step S212, Fr=0 is set by establishing the identifier Fr←Fr−1. Thereafter, the procedure returns to step S206 described above.

Further, when a positive result is obtained showing that a state where the reproducing operation is to be ended is established in step S207 described above, the series of processes shown in this drawing is ended.

Due to the series of processes as those described above, it is possible to appropriately perform tracking servo operation in different manners between the grooved track T-g and the no-groove track T-s in the optical disc Dsc1 in which the grooved tracks T-g and the no-groove tracks T-s are formed to be switched every predetermined rotation angle θ_{R} due to single spiral exposure operation. As a result, it is possible to appropriately reproduce the recorded information.

It is to be noted that, in the above description, the detection of the rotation angle θ_{R} that is to be a formation border between the grooved track T-g and the no-groove track T-s is achieved by recording the marker information in the optical disc Dsc1 in advance. However, for example, a motor including a FG (Frequency Generator), a PG (Pulse Generator), etc. may be used as the spindle motor 32 and the detection of the rotation angle θ_{R} may be performed by supplying the output thereof to the system controller 40.

### 3. Second Embodiment

### Double Spiral Exposure Operation

In the first embodiment, exposure operation is performed by one beam. Therefore, assuming that the tracks T are formed in a spiral fashion, it is necessary to switch the recording operation for each predetermined rotation angle θ_{R} in order to alternately arrange the grooved tracks T-g and the no-groove tracks T-s in the radial direction as described above.

In a second embodiment, in order to eliminate the necessity of switching of the recording operation for each predetermined rotation angle θ_{R} in such a manner, exposure operation is performed with the use of a beam for performing exposure operation for the grooved track T-g and of a beam for performing exposure operation for the no-groove track T-s. Specifically, exposure operation is performed to allow spiral-fashioned tracks as the grooved tracks T-g and spiral-fashioned tracks as the no-groove tracks T-s to be formed side by side with the use of these beams.

[3-1. Configuration of Exposure Device]

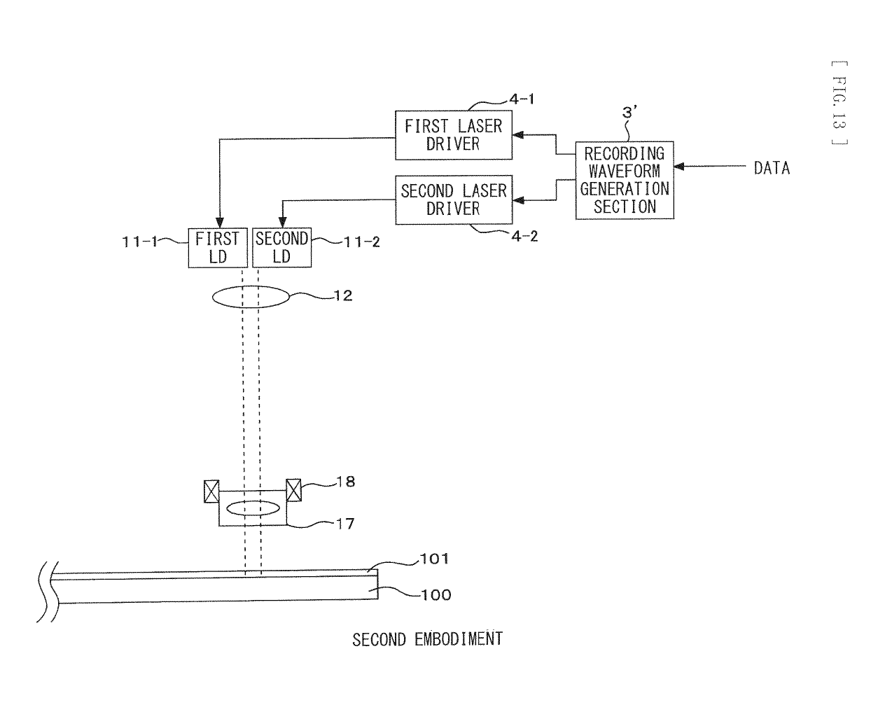

FIG. 13 is a diagram for explaining an internal configuration example of an exposure device (a master recording device) as the second embodiment.

It is to be noted that this FIG. 13 mainly shows a part different from that in the master recording device 1 of the first embodiment shown in FIG. 7 above, and illustration of other parts is omitted.

Here, in the following description, a part similar to the part already described will be designated with the same symbol and the description thereof will be omitted.

As can be seen from comparison with FIG. 7 described above, a master recording device in this case is different from the master recording device 1 of the first embodiment in that: a recording waveform generation section 3′ is provided instead of the recording waveform generation section 3; the laser driver 4 is omitted and a first laser driver 4-1 and a second laser driver 4-2 are provided; and further, the laser diode 11 is omitted and a first laser diode 11-1 and a second laser diode 11-2 are provided.

The recording waveform generation section 3′ divides the input data (recorded data) into two systems. The recording waveform generation section 3′ supplies, to the first laser driver 4-1, a recording waveform based on one of the divided data, and supplies, to the second laser driver 4-2, a recording waveform based on the other.

Here, in a case of the present example, the first laser diode 11-1 side serves for the exposure operation for the grooved track T-g, and the second laser diode 11-2 side serves for the exposure operation for the no-groove track T-s. Therefore, the recording waveform generation section 3′ in this case generates a waveform that allows the groove G to be inserted between the pits formed in accordance with the input data, as a recording waveform supplied to the first laser driver 4-1 side.

It is to be noted that, as a method of dividing data in the recording wavelength generation section 3′, for example, a method of assigning the input data to the first laser driver 4-1 side and the second laser driver 4-2 side on a predetermined data uni basis, etc. can be mentioned.

The first laser driver 4-1 and the second laser driver 4-2 perform light emission drive of the first laser diode 11-1 and the second laser diode 11-2 in accordance with the recording waveform supplied from the recording waveform generation section 3′, respectively.

The laser light emitted by these first laser diode 11-1 and second laser diode 11-2 is irradiated to the inorganic resist master 102 (the inorganic resist layer 101) via the collimator lens 12, the objective lens 17, etc. in a manner similar to that in the first embodiment.

In this case, the beam spot of the laser light (described as “first laser light”) emitted from the first laser driver 4-1 and a beam spot of the laser light (described as “second laser light”) emitted from the second laser diode 11-2 are arranged so that a spacing therebetween in the radial direction be 0.27 μm or smaller, i.e., a spacing out of the actual optical limit value (for example, 0.22 μm described above in the case of the present example).

Also, in this case, rotation drive and slide drive of the inorganic resist master 102 are performed in a manner similar to that in the first embodiment.

Accordingly, in the inorganic resist master 102 in this case, the grooved tracks T-g formed by exposure operation with the use of the above-described first laser light and the no-groove tracks T-s formed by exposure operation with the use of the above-described second laser light are formed in a spiral fashion separated from each other, and are formed so that the spacing of these tracks T in the radial direction be a spacing out of the optical limit value.

Also by such a master recording device of the second embodiment, it is possible to generate an optical disc recording medium in which the grooved tracks T-g and the no-groove tracks T-s are arranged alternately in the radial direction at a track pitch of 0.27 μm or smaller as in the case of the first embodiment.

In other words, it is possible to provide an optical disc recording medium that allows tracking servo operation to be performed appropriately (and therefore, allows higher recording density to be appropriately achieved) in a state where the tracks T are arranged at a pitch out of the optical limit value.

It is to be noted that, hereinafter, an optical disc recording medium formed using the master exposure device of the second embodiment is described as “optical disc Dsc2”.

[3-2. Configuration of Reproducing Device]

Here, as described above, according to the master recording device of the second embodiment, it is possible to obtain the optical disc Dsc2 in which the grooved-attached track T-g formed by exposure operation with the use of the first laser light and the no-groove track T-s formed by exposure operation with the use of the above-described second laser light are formed in a spiral fashion separated from each other, and the spacing between these tracks T in the radial direction is 0.27 μm or smaller. In a case of reproducing such an optical disc Dsc2 as the second embodiment, it is not necessary to perform tracking servo operation in different manners as in the first embodiment, and tracking servo operation may be performed based on the tracking error signal TE (see FIGS. 4 and 5, etc.) itself generated based on reflected light from the optical disc Dsc2.

Specifically, when, concerning the laser light for reproducing operation, laser light (described as “first reproducing laser light”) for reproducing the recorded information in the grooved track T-g and laser light (described as “second reproducing laser light”) for reproducing the recorded information in the no-groove track T-s are irradiated via a common objective lens, the first and second reproducing laser lights are allowed to follow the grooved track T-g and the no-groove track T-s, respectively, by performing position control of the above-described objective lens in accordance with the tracking error signal TE generated based on the reflected light of the above-described first reproducing laser light. As a result, the recorded information in these grooved track T-g and no-groove track T-s is allowed to be read at the same time.

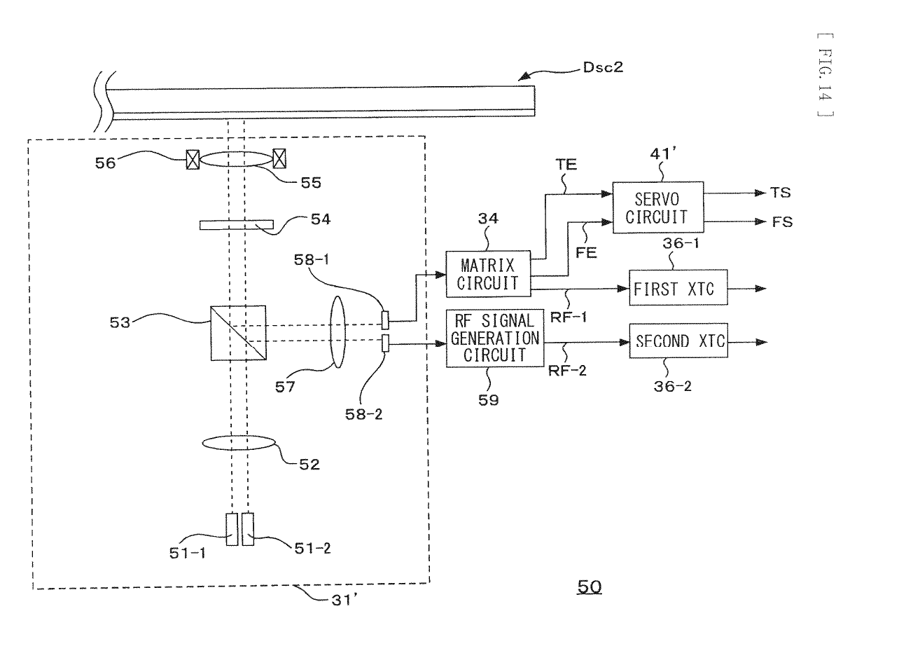

FIG. 14 is a diagram for explaining an internal configuration example of a reproducing device (assumed to be a disc drive device 50) of the second embodiment that performs reproduction of the optical disc Dsc2.

It is to be noted that FIG. 14 mainly illustrates parts different from those in the disc drive device 30 in the first embodiment shown in FIG. 10 described above, and illustration of other parts is omitted.

As can be seen from comparison with FIG. 10 described above, the disc drive device 50 of the second embodiment is different from the disc drive device 30 of the first embodiment in that: an optical pick-up 31′ is provided instead of the optical pick-up 31; a servo circuit 41′ is provided instead of the servo circuit 41; and further, an RF signal generation circuit 59 is additionally provided and two cross-talk cancel circuits 36-1 and 36-2 are provided as the cross-talk cancel circuit 36.

First, in the optical pick-up 31′, a first laser 51-1 and a second laser 51-2 are provided. The first laser 51-1 is to be a light source of the above-described first reproducing laser light (the laser light for reproducing the grooved track T-g). The second laser light 51-2 is to be a light source of the second reproducing laser light (the laser light for reproducing the no-groove track T-s).

Here, beam spots (beam spots formed on the optical disc Dsc2) of the first and second reproducing laser lights are set with an arrangement spacing in the radial direction that is to be equal to the track pitch Tp. In other words, the optical system in this case is designed to achieve such an arrangement spacing.

The first reproducing laser light emitted by the first laser 51-1 and the second reproducing laser light emitted by the second laser 51-2 are allowed to be parallel lights via the collimator lens 52. The parallel light passes through a polarizing beam splitter 53 and a ¼ wavelength plate 54, and thereafter, is irradiated to the optical disc Dsc2 via an objective lens 55 held by a biaxial actuator 56.

Reflected light (returned light) of the respective first and second reproducing laser lights obtained by the optical disc Dsc2 enters the polarizing beam splitter 53 via the objective lens 55 and the ¼ wavelength plate 54.

Here, the returned light of each laser light that reaches the polarizing beam splitter 53 in such a manner passes through the ¼ wavelength plate 45 twice for an outward path and a returning path. Therefore, a polarization direction of such returned light is rotated by 90°, and therefore, the returned light is reflected by the polarizing beam splitter 53.

The respective returned lights reflected by the polarizing beam splitter 53 are received by a first light receiving section 58-1 side and a second light receiving section 58-2 side corresponding thereto via a light condensing lens 57. Specifically, the returned light of the first reproducing laser light is received by the first light receiving section 58-1, and the returned light of the second reproducing laser light is received by the second light receiving section 58-2.

Out of these, the first light receiving section 58-1 is configured to receive light by dividing the returned light of the first reproducing laser light by a plurality of detector, for example, a four-divided detector in order to generate the tracking error signal TE and the focus error signal FE.

The matrix circuit 34 generates the RF signal, the focus error signal FE, and the tracking error signal TE based on the light reception signal obtained by the first light receiving section 58-1 in a manner similar to that in the matrix circuit 34 described above.

Here, the RF signal generated by the matrix circuit 34 in this case is described hereinafter as “first reproduction information signal RF-1” in order to distinguish such a signal from the RF signal generated by an RF signal generation circuit 59, which will be described alter, based on the returned light of the second reproducing laser light.

As shown in the drawing, the first reproduction information signal RF-1 outputted from the matrix circuit 34 is supplied to the first cross-talk cancel circuit 36-1, and is subjected to a cross-talk cancel process similar to that in the cross-talk cancel circuit 36 described above.

Although it is not illustrated, the first reproduction information signal RF-1 subjected to the cross-talk cancel process in the first cross-talk cancel circuit 36-1 is supplied to the data detection process section 35.

Further, the focus error signal FE and the tracking error signal TE outputted from the matrix circuit 34 are supplied to the servo circuit 41′.

Here, compared to the servo circuit 41 described above, in the servo circuit 41′, the configuration related to performing tracking servo operation in different manners (the inverting circuit 41b and the switch SW1 in FIG. 11A and the adder 41C and the switch SW2 in FIG. 11B) is omitted.

Although it is not illustrated, the tracking servo signal TS and the focus servo signal FS obtained by the servo circuit 41′ are supplied to a biaxial driver 46.

Thus, tracking servo operation is performed so that the beam spot of the first reproducing laser light trace the grooved track T-g. Further, as described above, the spacing between the beam spot of the first reproducing laser light and the beam spot of the second reproducing laser light in the radial direction is equal to the track pitch Tp. Therefore, the beam spot of the second reproducing laser light is allowed to follow the no-groove track T-s.

Moreover, a light reception signal related to the returned light of the second reproducing laser light obtained by the second light receiving section 58-2 is supplied to the RF signal generation circuit 59.

The RF signal generation circuit 59 generates an RF signal based on the light reception signal obtained by the second light receiving section 58-2. It is to be noted that the RF signal generated by the RF signal generation circuit 59 is described as “second reproduction information signal RF-2” in order to distinguish such a signal from the RF signal generated by the matrix circuit 34 described above.

The second reproduction information signal RF-2 is supplied to the second cross-talk cancel circuit 36-2, and is subjected to a cross-talk cancel process similar to that in the cross-talk cancel circuit 36 described above.

Although it is not illustrated, the second reproduction information signal RF-2 subjected to the cross-talk cancel process in the second cross-talk cancel circuit 36-2 is supplied to the data detection process section 35.

It is to be noted for confirmation that, since the first cross-talk cancel circuit 36-1 and the second cross-talk cancel circuit 36-2 are provided, the cross-talk component from the adjacent track is suppressed for both of the grooved track T-g and the no-groove track T-s. Therefore, it is possible to appropriately obtain the reproduction data.

It is to be noted that, for the sake of convenience in description above, light sources are separately provided for irradiating, to the optical disc Dsc2, the beam for reproducing the grooved track T-g and the beam for reproducing the no-groove track T-s. However, it goes without saying that a common light source may be used, and a configuration may be adopted in which the laser light from the common light source is split to form two beam spots.

### 4. Third Embodiment

### Single Spiral Recording for Recordable-Type Disc

In the first and second embodiments above, there has been described the exposure method for manufacturing the ROM-type optical disc recording medium and the reproducing method (mainly, the tracking servo control method) related to the ROM-type optical disc recording medium. However, the present technology is also applicable to a recordable-type optical disc recording medium.

Specifically, the present technology is also applicable to a case of performing mark recording operation in a recording layer in a recordable-type optical disc recording medium in which no position guide as a groove is formed in the recording layer.

Hereinafter, as third and fourth embodiments, Example will be described related to recording operation related to a recordable-type optical disc recording medium in which no position guide is formed in the recording layer as described above.

[4-1. Structure of Optical Disc Recording Medium]

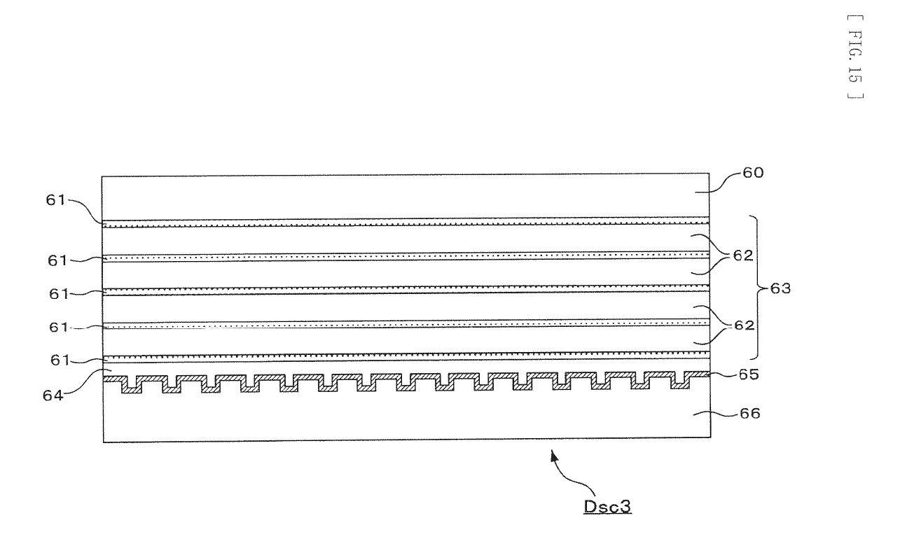

FIG. 15 illustrates a cross-sectional structure of an optical disc recording medium (described as “multi-layered recording medium Dsc3”) to be the target of the recording operation in the third embodiment.

As illustrated, in the multi-layered recording medium Dsc3, a cover layer 60, a recording layer 63, a adhesion layer 64, a reflection film 65, and a substrate 66 are formed in order from an upper layer side.

Here, “upper layer side” in the present specification indicates an upper layer side in a case where a surface on which laser light from a recording device (a recording-reproducing device 70) described later is incident is assumed to be an upper surface.

In the multi-layered recording medium Dsc3, the cover layer 60 may be configured, for example, of resin, and serves as a protection layer of the recording layer 63 formed on a lower layer side thereof.

The recording layer 63 is configured to have a plurality of semitransparent recording films 61 as shown in the drawing. Specifically, the recording layer 63 in this case has a multi-layered structure in which intermediate layers 62 are inserted between the respective plurality of semitransparent recording films 61. In other words, the recording layer 63 in this case is formed by repeating lamination of the semitransparent recording film 61→the intermediate layer 62→the semitransparent recording film 61→the intermediate layer 62 . . . →the semitransparent recording film 61.

In the case of the present example, the recording layer 63 is provided with five semitransparent recording films 61. In other words, the number of recordable layers in the recording layer 63 is “5”.

Here, it is to be noted that no position guide is formed in accordance with the formation of the grooves, the pit lines, etc. in each of the semitransparent recording film 61 as clearly shown in the drawing. In other words, the semitransparent recording film 61 is formed in a planar state.

On the lower layer side of the recording layer 63, the reflection film 65 is formed with the adhesion layer (the intermediate layer) 64 configured of a desirable adhesive material in between.

A position guide for guiding a recording/reproducing position is formed in the reflection film 65. It is to be noted that the wording “the position guide is formed in the reflection film” means that the reflection film is formed on an interface on which the position guide is formed.

Specifically, in this case, the position guide is formed on one surface side of the substrate 66 in the drawing, and accordingly, a cross-sectional shape having concavities and convexities as shown in the drawing is provided. The reflection film 65 is formed on a surface having the concave-convex cross-sectional shape of the substrate 66, and thus, the position guide is formed on the reflection film 65.

It is to be noted that the substrate 66 may be configured, for example, of resin such as polycarbonate and acryl. The substrate 66 may be generated, for example, by injection molding using a stamper for providing the concave-convex cross-sectional shape as the above-described position guide.

Here, as performed in a current recordable-type optical disc, it is possible to record information (absolute position information: radial position information and rotation angle information) indicating an absolute position in a direction parallel to a recording in-plane direction of the multi-layered medium Dsc3 by forming the above-described position guide. For example, this absolute position information is allowed to be recorded by modulation of a wobble cycle of a groove when the above-described position guide is formed with the use of the groove. Also, the absolute position information is allowed to be recorded by modulation of a length, formation pitch, etc. of the pits when the above-described position guide is formed with the use of a pit line.

It is to be noted that no position guide is formed inside the recording layer 63 as described above. The recording position in the recording layer 63 is controlled based on the reflected light from the reflection film 65 in which the position guide is formed as will be described above.

In this sense, hereinafter, the reflection film 65 (a reflection surface) in which the position guide is formed is described as “reference surface Ref”.

[4-2. Position Control Method Utilizing Reference Surface]

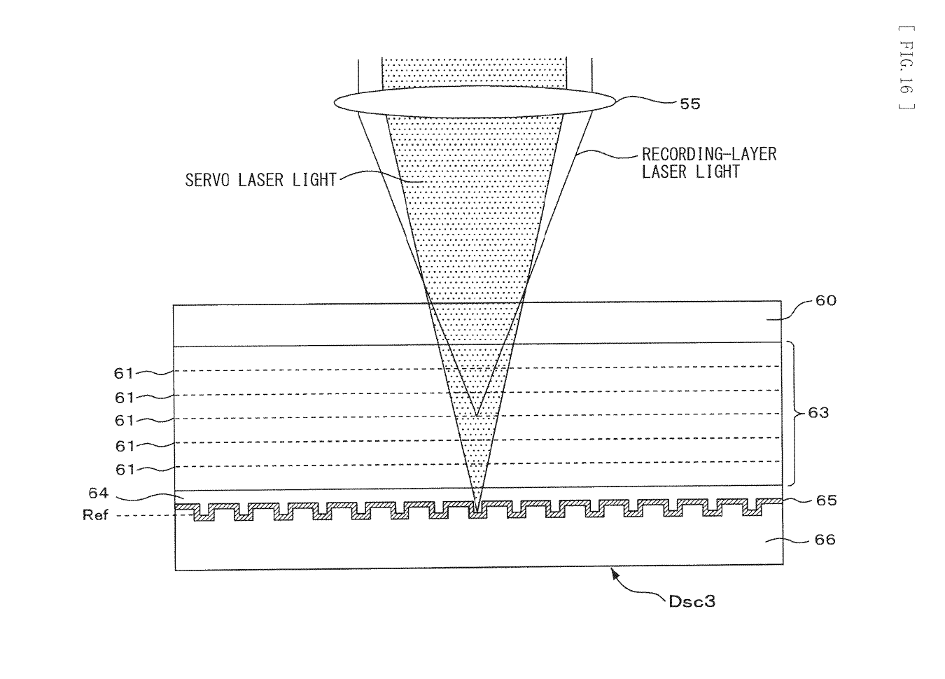

FIG. 16 is a diagram for explaining a position control method utilizing a position guide formed in the reference surface Ref.

With respect to the multi-layered recording medium Dsc3 having the above-described configuration, laser light (hereinafter, described as “servo laser light”) for performing position control based on the position guide in the reference surface Ref is irradiated together with recording-layer laser light, in order to achieve position control of the recording-layer laser light to be irradiated targeting the recording layer 63.

Specifically, the recording-layer laser light and the servo laser light are irradiated to the multi-layered recording medium Dsc3 via a common objective lens (the objective lens 55) as shown in the drawing.

In this case, in order to achieve accurate tracking servo operation, an optical axis of the recording-layer laser light is allowed to coincide with an optical axis of the servo laser light.

At the time of recording a mark targeting the recording layer 63 (the desired semitransparent recording film 61), the servo laser light is irradiated so as to focus on the reflection surface (the reference surface Ref) of the reflection film 65 as shown in the drawing. The position of the objective lens 55 is controlled (in other words, tracking servo operation is performed) in accordance with a tracking error signal obtained based on that reflected light.

Thus, a position, in a tracking direction, of the recording-layer laser light to be irradiated via the same objective lens 55 is controlled to be at a desirable position.

On the other hand, position control at the time of reproducing operation is allowed to be achieved as follows.

At the time of reproducing operation, a mark line (in other words, a recorded track) is formed in the semitransparent recording film 61. Therefore, tracking servo operation is allowed to be performed with the use of the recording-layer laser light itself targeting the mark line. Specifically, the tracking servo operation at the time of reproducing operation is allowed to be achieved by controlling the position of the objective lens 55 in accordance with the tracking error signal obtained based on the reflected light of the recording-layer laser light.

Here, if light having a wavelength band same as that of the recording-layer laser light is used as the servo laser light in the above-described position control method, it is difficult to avoid increasing the reflectance of the recording-layer laser light with respect to the reference surface Ref that should obtain the reflected light of the servo laser light. In other words, a stray light component is increased accordingly, and reproducing performance may be extremely degraded.

Therefore, lights having different wavelength bands are used for the respective servo laser light and recording-layer laser light, and a reflection film having wavelength selectivity is used as the reflection film 65 forming the reference surface Ref.

Specifically, in the case of the present example, the wavelength of the recording-layer laser light is about 405 nm that is similar to the wavelength in the case of the BD. The wavelength of the servo laser light is about 650 nm that is similar to the wavelength in the case of DVD (Digital Versatile Disc). Further, as the reflection film 65, a wavelength-selective reflection film that selectively reflects light having a wavelength band same as that of the servo laser light and transmits or absorbs light having other wavelength.

Such a configuration prevents occurrence of unnecessary reflected light component of the recording-layer laser light from the reference surface Ref, and secures favorable S/N (sound-to-noise ratio).

[4-3. Arbitrary Pitch Spiral Movement Control]

By the way, in the present embodiment, one reason for that the recording operation is performed by performing position control based on the position guide formed in the optical disc recording medium is as follows. That is because the recording device assumed in the present embodiment is a drive device used by a general user. Specifically, in such a drive device, it is difficult to secure high mechanical accuracy compared to a master recording device used by a disc manufacturer etc. (in terms of cost, etc.). Therefore, it is difficult to achieve accurate spiral movement control only by slide control as described above.

By performing the above-described position control, it is possible to form a mark line (a track T) in a desirable position in the recording layer 63 even in a case where mechanical accuracy is not allowed to be secured.

However, it is to be noted that, in the present technology, it is necessary to allow the pitch of the tracks T to be formed in the recording layer 63 to be a pitch out of the optical limit value.

Here, as described above, if the recording-layer laser light and the servo laser light have the same wavelength, stray light resulting from unnecessary reflection is disadvantageously increased. Therefore, the recording-layer laser light and the servo laser light are allowed to have different wavelengths. Further, concerning the relationship of the wavelengths, the recording-layer laser light is allowed to have a shorter wavelength than that of the servo laser light giving priority to the recording density of the recording layer 63. Specifically, the optical conditions in the reference surface Ref are set to optical conditions (λ=about 650 nm, NA=about 0.65) almost similar to those of the DVD in order to achieve high-density recording in the recording layer 63 by setting the optical conditions in the recording layer 63 to the optical conditions (λ=about 405 nm, NA=about 0.85) almost similar to those of the BD.

In this case, the track pitch of the reference surface Ref has an optical limit value of about 0.500 μm. Accordingly, if tracking servo operation related to the recording-layer laser light is performed as described above simply in accordance with the track pitch in the reference surface Ref, it is not possible to achieve recording operation in the recording layer 63 at a pitch out of the optical limit value.

Taking into consideration the above-described point, in the third embodiment, a structure achieving spiral movement at an arbitrary pitch disclosed, for example, in the following Reference Literatures 5 and 6 is adopted as the structure of the reference surface Ref.

Reference Literature 5: Japanese Unexamined Patent Application Publication No. 2010-225237

Reference Literature 6: Japanese Unexamined Patent Application Publication No. 2011-198425

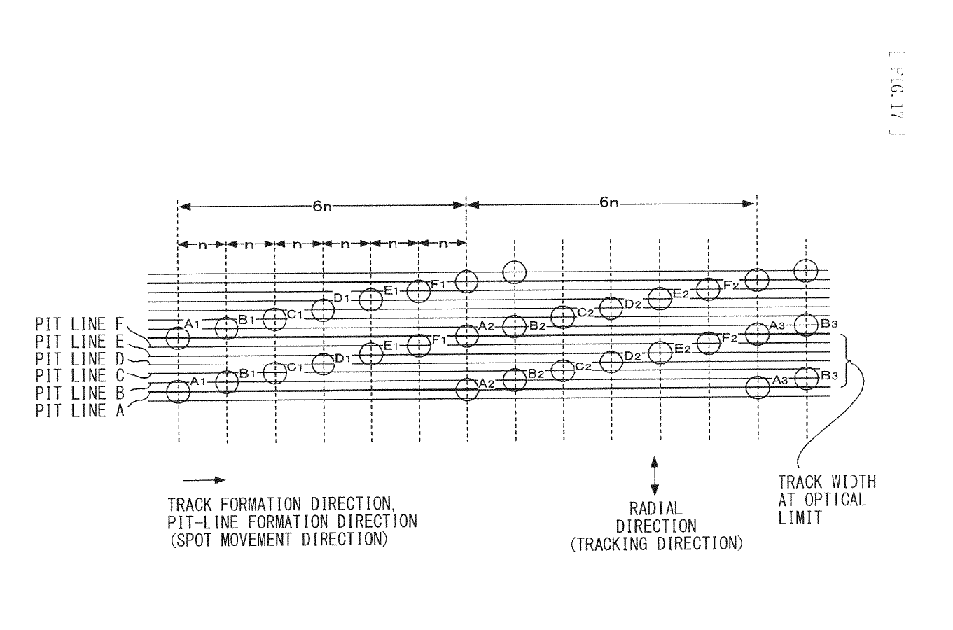

For confirmation, description will be provided of a structure of the reference surface Ref that achieves spiral movement at an arbitrary pitch and a position control method based thereon referring to FIGS. 17 to 21.

FIG. 17 is a diagram (a planar view) illustrating, in an enlarged manner, part of a surface of the reference surface Ref of the multi-layered recording medium Dsc3 of the third embodiment.

First, in FIG. 17, a direction from the left to the right of the paper plane is set as a formation direction of pit lines, that is, a formation direction of tracks. The beam spot of the servo laser light for the position control described above moves from the left to the right of the paper plane in accordance with the rotation of the multi-layered recording medium Dsc3.

Also, a direction (a vertical direction in the paper plane) orthogonal to the formation direction of pit lines is a radial direction of the multi-layered recording medium Dsc3.

Further, in FIG. 17, A to F shown by white circles in the drawing represent allowable positions in pit-formation. Specifically, in the reference surface Ref, a pit is formed only in the allowable position, and is not formed in a position other than the allowable position.

Also, a difference in symbols of A to F in the drawing represents a difference in pit line (a difference in pit lines arranged in the radial direction). The number attached to these symbols of A to F represents a difference in allowable positions in pit-formation on the pit line.

Here, a spacing (a track width at optical limit) shown by a black thick line in the drawing represents a minimum track pitch (a track pitch having the optical limit value) determined by the optical conditions of the reference surface Ref. As can be understood from this, in the reference surface Ref in this case, six pit lines of A to F in total are arranged in the radial direction at a pitch out of the optical limit value.

However, when simply arranging the plurality of pit lines at a pitch out of the optical limit value, the formation positions of the pits may be overlapped with one another in the pit-line formation direction. In other words, the spacing of the pits in the pit-line formation direction may be out of the optical limit.

Moreover, as can be clearly understood based on the description later, it is necessary to separately obtain tracking error signal for the respective pit lines of A to F in order to achieve the spiral movement at an arbitrary pitch.

Accordingly, a special idea is necessary for the arrangement of the respective pit lines also in terms of this point.

Taking into consideration these points, the following conditions are provided concerning the respective pit lines of A to F in the reference surface Ref in this case.

That is:

1) The spacing between the allowable positions in pit-formation is limited to a predetermined first distance in the respective pit lines of A to F.

2) The respective pit lines of A to F having thus limited spacing between the allowable positions are arranged so that the respective allowable positions are shifted by a predetermined second distance in the pit-line formation direction. (In other words, phases of the respective pit lines are shifted by the above-described second distance).

Here, the spacing (the above-described second distance) in the pit-line formation direction of the respective allowable positions in the pit lines of A to F arranged in the radial direction is set as “n”. In this case, by arranging the respective pit lines of A to F so that the above-described condition 2) be satisfied, all of the spacings between the respective allowable positions between pit lines A-B, pit lines B-C, pit lines C-D, pit lines D-E, pit lines E-F, and pit lines F-A become “n” as shown in the drawing.

Moreover, the spacing (the above-described first distance) of the allowable positions in the respective pit lines of A to F are set to achieve six pit-line phases in total from A to F in this case, and therefore is 6n.

As can be understood from this, in the reference surface Ref in this case, the plurality of pit lines of A to F that have different pit-line phases from one another are formed so that the respective phases be shifted by the above-described “n” under a condition that the basic cycle is set as the above-described “6n”.

Accordingly, in a method of achieving spiral movement at an arbitrary pitch described later, it is possible to separately obtain the tracking error signals for the respective pit lines of A to F.

At the same time, in a case where the respective pit lines of A to F are arranged in the radial direction at a pitch out of the optical limit value in the reference surface Ref as in the case of the present embodiment, the spacing between the pits in the pit-line formation direction is prevented from being out of the optical limit.

Here, the optical conditions in the reference surface Ref are set to optical conditions of λ=about 650 nm and NA=about 0.65 which are similar to those of the DVD as described above. In accordance therewith, a section length of each allowable position in this case is set to a section length corresponding to 3T that is the same as that of the shortest mark in the DVD. Also, a spacing between edges of the respective allowable positions of A to F in the pit-line formation direction is also set to the length corresponding to 3T in a similar manner.

As a result, the above-described conditions 1) and 2) are satisfied.

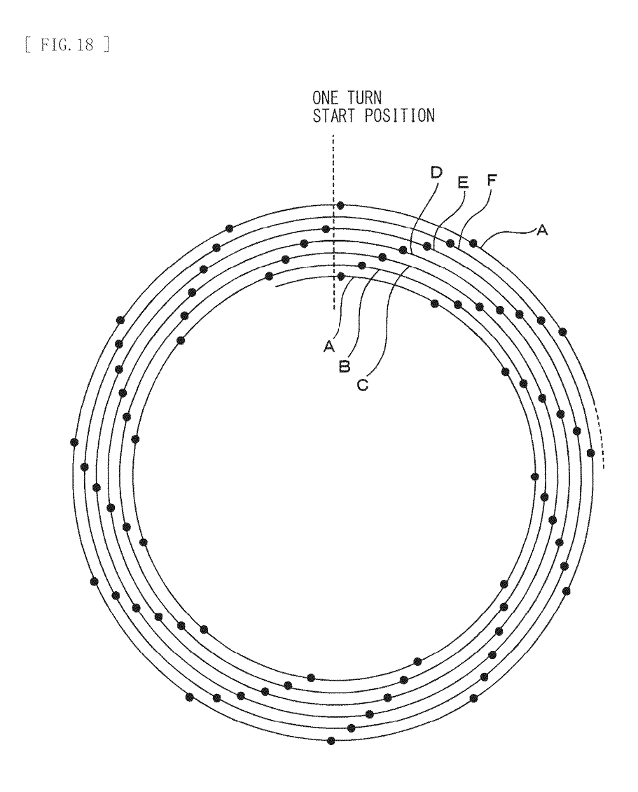

Subsequently, in order to understand a formation state of the pits in the entire reference surface Ref, description will be provided of a specific method of forming a pit line referring to FIG. 18.

It is to be noted that FIG. 18 schematically illustrates part (seven lines) of the pit lines formed in the reference surface Ref. In the drawing, a black dot represents the allowable position in pit-formation.

As can be seen by referring to this FIG. 18, the pit lines are formed in a spiral fashion in the reference surface Ref in this case.

Further, the above-mentioned conditions 1) and 2) related to the pit lines arranged in the radial direction are satisfied by determining the allowable positions so that the pit-line phases are shifted by the above-described second distance (“n”) on a one-pit-line-turn basis.

For example, in the example shown in FIG. 18, the allowable positions are determined so that the pit-line phase as the pit line A be obtained in the first turn of the pit lines. In the second turn of the pit lines counted using the one-turn start position (at a predetermined angle position) as a reference in the drawing, the allowable positions are determined so that the pit-line phase as the pit line B be obtained. In a similar manner, the allowable positions are set so that the pit-line phases as the pit lines C, D, E, F, A, and so on be obtained in the third round, the fourth round, the fifth round, the six round, the seventh round, and so on, respectively. In such a manner, the allowable positions in the respective turns of the pit lines are determined so that the pit-line phases are shifted by the second distance “n” for every turn of the pit lines.

It is to be noted that, as disclosed in the above-described Reference Literature 5, etc., address information (absolute position information) is recorded separately in each of the pit lines of A to F.

Here, as shown in FIG. 18, in the case of the present example, the pit lines in the reference surface Ref have a structure in which the allowable positions in the respective rounds of the pit lines are determined so that the phases of the pit lines are switched in order of A→B→C→D→E→F→A . . . on one-turn basis in the pit lines where the pit lines are formed in a single-spiral fashion, that is, so that the pit-line phases are shifted by the second distance “n” on one-pit-line-turn basis.

Accordingly, if tracking servo operation is allowed to be performed, for example, targeting one pit line out of A to F, it is possible to achieve a pitch that is one-sixth of the optical limit value in the reference surface Ref as the spiral pitch. For example, in the case of the present example, it is possible to achieve a pitch of about 0.083 μm obtained by 0.500 μm/6, that is a pitch out of the optical limit value (of 0.27 μm or smaller) of the recording layer 63.

However, the respective pit lines in the reference surface Ref may not be a single spiral as shown in FIG. 18. The respective pit lines in the reference surface Ref may be formed in a fashion of six spirals of A to F, or may be formed in a concentric circle fashion. In such a case, it is not possible to achieve spiral movement at a pitch out of the optical limit value, or it is not possible to achieve spiral movement itself when tracking servo operation is performed targeting one pit line as described above.

Therefore, by setting the above-described conditions 1) and 2) as the formation conditions of the pit lines in the reference surface Ref, it is allowed to perform tracking servo operation in different manners targeting each of the pit lines arranged at a pitch out of the optical limit value. In such a state, offset that increases with elapse of time is provided to the tracking error signal and sequential movement between the respective pit lines of A to F is performed. Thus, the spiral movement at an arbitrary pitch is achieved.

Here, in order to achieve the spiral movement at an arbitrary pitch, it is necessary to sequentially switch the pit line targeted for servo operation to a pit line adjacent on the outer side, for example, as pit line A→pit line B→pit line C . . . .

In order to achieve an operation of sequentially switching the pit line targeted for servo operation in such a manner, it is necessary to allow the tracing error signals related to the pit lines configured of the respective phases of A to F to be obtained separately. This is because it is not possible to switch the pit line targeted for servo operation if the tracking error signals for the respective pit lines of A to F are not distinguished.

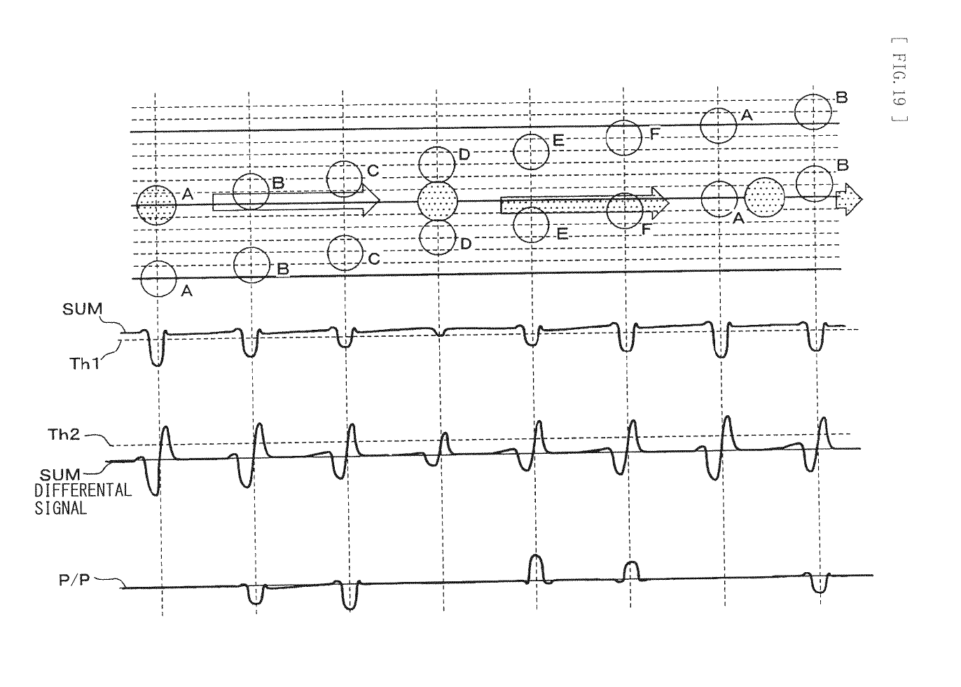

FIG. 19 schematically illustrates a relationship between a state of the movement of the spot of the servo laser light on the reference surface Ref in accordance with the rotation of the multi-layered recording medium Dsc3 and waveforms of the SUM signal, the SUM differential signal, and the P/P signal obtained at that time.

It is to be noted that the SUM differential signal is a signal obtained by differentiating the SUM signal obtained based on the reflection light of the servo laser light.

Here, for the sake of convenience in description, it is assumed that pits are formed in all of the allowable positions in pit-formation in FIG. 19.

As illustrated, in accordance of the movement of the beam spot of the servo laser light in accordance with the rotation of the multi-layered medium Dsc3, a signal level of the SUM signal reaches its peak in a cycle in accordance with the arrangement spacing of the respective pits in A to F in the pit-line formation direction. In other words, this SUM signal represents the spacing (a formation cycle) of the respective pits in A to F in the pit-line formation direction.

Here, in the example shown in this drawing, it is assumed that the beam spot is allowed to move along the pit line A. Therefore, the peak value of the SUM signal is at the maximum when the beam spot passes the formation position of the pit A in the pit-line formation direction. Also, the peak value tends to decrease gradually from the formation position of the pit B to the formation position of the pit D. Thereafter, the peak value is changed to tend to increase in order of the formation position of the pit E→the formation position of the pit F. The peak value becomes at the maximum when the beam spot arrives again at the formation position of the pit A. In other words, in the above-described formation positions of the pits E and F in the pit-line formation direction, the peak value of the SUM signal is influenced by the pits in the pit lines E and F that are adjacent in the inner side. Therefore, the peak value of the SUM signal is increased in order for the respective formation positions of the pits E and F.

Moreover, as the SUM differential signal and the P/P signal as the tracking error signal, respective waveforms as shown in the drawing are obtained.

Here, it is to be noted that the P/P signal as the tracking error signal is obtained so as to show a relative position relationship between the beam spot and the pit lines for the respective pit-formable positions of A to F that are away from one another by the predetermined spacing “n”.

Moreover, the SUM differential signal shows a spacing in the pit-line formation direction of the pit formation positions (specifically, the allowable positions in pit-formation) of the respective pit lines A to F.

Therefore, based on this SUM differential signal, a clock CLK representing the spacing between the allowable positions of the respective pit lines A to F in the pit-line formation direction is allowed to be obtained.

Specifically, the clock CLK in this case is a signal that has a rising position (timing) at a position (timing) corresponding to a center position (a peak position) of each pit.

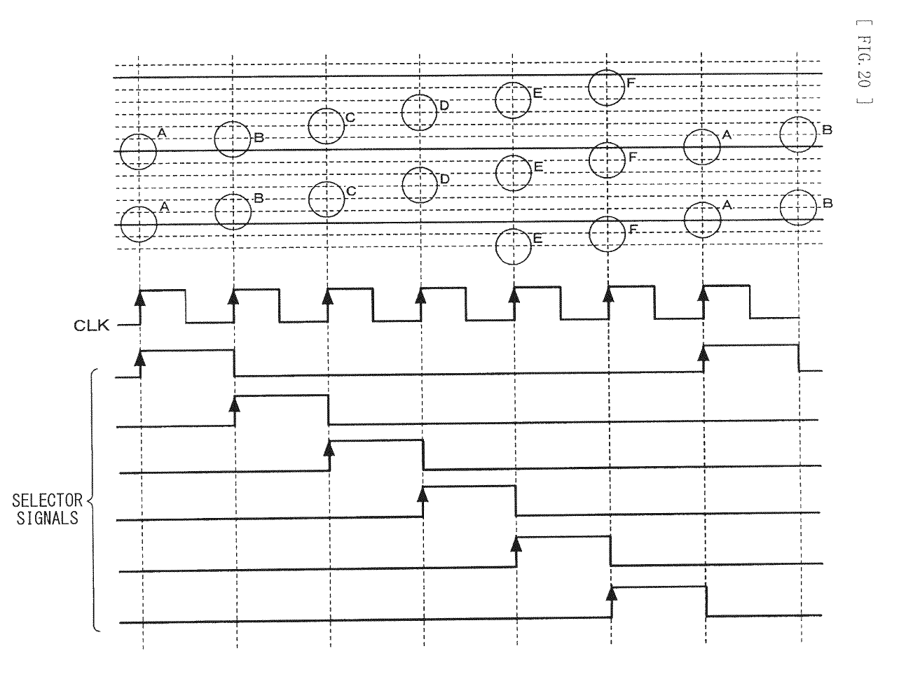

FIG. 20 schematically shows a relationship between the clock CLK, waveforms of respective selector signals generated based on the clock CLK, and (part of) the respective pit lines formed in the reference surface Ref.

As shown in this drawing, the clock CLK is a signal that rises at a timing corresponding to the peak position of each pit (allowable position), and has a falling position at a middle point between the respective rising positions.

Such a clock CLK is allowed to be generated by a PLL (Phase Locked Loop) process that uses, as an input signal (a reference signal), a timing signal (indicating zero crossing timing of the SUM differential signal) generated from the SUM differential signal.

Further, from the clock CLK that has a cycle in accordance with the formation spacing of the pits A to F in such a manner, six types of selector signals are generated that each show a timing of the allowable position in each of A to F. Specifically, these selector signals are each generated by dividing the frequency of the clock CLK to ⅙ thereof. Also, the respective phases of the selector signals are shifted by ⅙ cycle. In other words, these selector signals are each generated by dividing the frequency of the clock CLK to ⅙ thereof for each timing so that the respective rising timings are shifted by ⅙ cycle.

These selector signals are each a signal representing a timing of the allowable position in the pit line corresponding to one of A to F. In the present example, these selector signals are generated, and an arbitrary selector signal is selected. Tracking servo control is performed in accordance with the P/P signal in a period represented by the selected selector signal, and thereby, the beam spot of the servo laser light is allowed to trace on an arbitrary pit line out of the pit lines of A to F. Accordingly, thus, a pit line to be targeted for servo operation is allowed to be arbitrarily selected out of the respective pit lines of A to F.

Thus, the respective selector signals representing the timings of the allowable positions of the pit lines corresponding to A to F are generated. An arbitrary selector signal out of these selector signals is selected, and tracking servo control is performed based on the tracking error signal (the P/P signal) in a period represented by the selected selector signal. Thus, it is possible to achieve tracking servo operation targeting an arbitrary pit line out of A to F. In other words, by selecting the above-described selector signal, it is possible to perform switching of the tracing error signal for the pit line targeted for servo operation, and thereby, switching of the pit line targeted for servo operation is achieved.

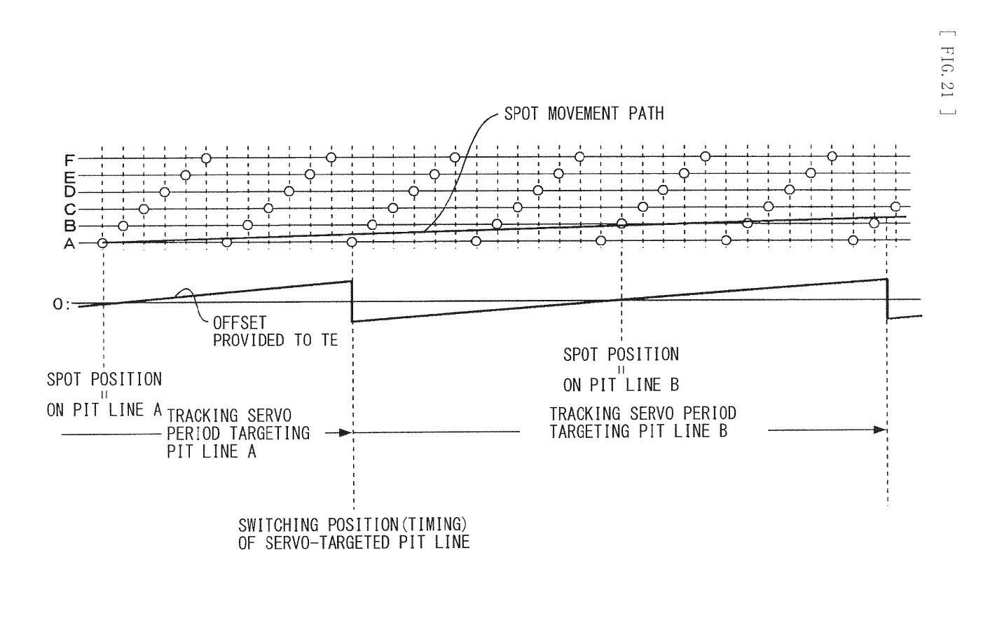

FIG. 21 is a diagram for explaining a specific method for achieving spiral movement at an arbitrary pitch. FIG. 21 shows a relationship between offset provided to the tracking error signal TE and a movement path of the beam spot on the reference surface Ref.

It is to be noted that, the tracking error signal TE referred to herein is a signal obtained by sampling and holding the P/P signal based on the above-described selector signal. In other words, the tracking error signal TE referred to herein means the P/P signal (the tracking error signal) for the pit line targeting for servo operation.

This FIG. 21 shows a state that the beam spot moves as the pit line A→the pit line B by the provision of the offset.

First, in a case where a method is adopted of sequentially switching the pit line targeted for servo operation in order to achieve the spiral movement at an arbitrary pitch, the switching position (timing) is determined in advance. In the example shown in this drawing, such a switching position of the servo-targeted pit line is set in a position (in the radial direction) that is a middle point between the pit lines in adjacent relationship.

Here, when achieving a certain spiral pitch, a position on the disc in which the beam spot should pass in order to achieve that spiral pitch is allowed to be determined in advance by calculation based on the format of the reference surface Ref. Accordingly, as can be also understood from this, the position in which the beam spot arrives at the middle point between the adjacent pit lines is allowed to be determined in advance by calculation as described above.

The pit line targeted for servo operation is sequentially switched to a pit line adjacent on the outer side to the pit line that has been targeted for servo operation in accordance with the arrival at the position (which clock in which address block) as the above-described middle point determined by calculation, etc. in advance.

On the other hand, in order to move the beam spot in the radial direction, the offset having a sawtooth-shaped waveform as shown in the drawing is provided to the tracking error signal TE. By setting a slope of this offset, it is possible to set the spiral pitch to an arbitrary pitch.

Here, the offset provided for achieving the arbitrary spiral pitch has a waveform having a polarity that varies for every middle point described above due to sequential switching of the pit line targeted for servo operation at a timing where the beam spot arrives at the middle point between the adjacent pit lines as described above. In other words, an offset amount necessary to move the beam spot to the position to be the above-described middle point may be, for example, “+α” at the time of servo operation targeting the pit line A, and may be “−α” at the time of servo operation targeting the pit line B adjacent thereto. Therefore, it is necessary to invert the polarity of the above-described offset at a timing of switching the pit line targeted for servo operation as the timing where the beam spot arrives at the above-described middle point. According to this point, a waveform of the offset to be provided in this case is a waveform having a sawtooth-shaped wave as described above.

It is to be noted for confirmation that, also when the offset has such a waveform, it is possible to determine it in advance by calculation, etc. based on the information on the spiral pitch to be achieved and the information of the format of the reference surface Ref.

Thus, while providing the offset having a sawtooth-shaped wave determined in advance to the tracking error signal TE, the pit line targeted for tracking servo operation is switched to a pit line adjacent on the outer side to the pit line that has been targeted therefore at every timing when the beam spot arrives at a predetermined position between the adjacent pit lines determined in advance as the above-described middle point.

Thus, it is possible to achieve the spiral movement at an arbitrary pitch.

By achieving the spiral movement at an arbitrary pitch independent of the optical limit value of the reference surface Ref in such a manner, it is possible to record the mark line in the recording layer 63 at a track pitch Tp out of the optical limit value of the recording layer 63.

Specifically, the recording operation with respect to the recording layer 63 (the desirable semitransparent recording film 61) in this case is performed by performing switching between recording operation of the grooved mark line and the recording operation of the no-groove mark line for every one rotation of the disc (specifically, for every rotation angle θ_{R}) as in the case of the first embodiment with the use of the recording-layer laser light. This is performed under a state where the position control for achieving the above-described spiral movement at an arbitrary pitch is performed as the position control of the objective lens 55 based on the reflected light of the servo laser light.

Accordingly, recording operation is allowed to be performed with respect to the multi-layered recording medium Dsc3 as a recordable-type optical disc so that the grooved tracks (mark lines) T-g and the no-groove tracks (mark lines) T-s are arranged alternately in the radial direction at a track pitch of 0.27 μm or smaller.

Accordingly, it is possible to provide an optical disc recording medium that allows tracking servo operation to be performed appropriately (accordingly, allows higher recording density to be achieved appropriately) under a state where the tracks T are arranged at a pitch out of the optical limit value.

It is to be noted that, in the third embodiment, determination of whether it has reached the rotation angle θ_{R} at the time of recording is performed based on a result of detection of the marker information embedded in the reference surface Ref in advance.

[4-4. Configuration of Recording-Reproducing Device]

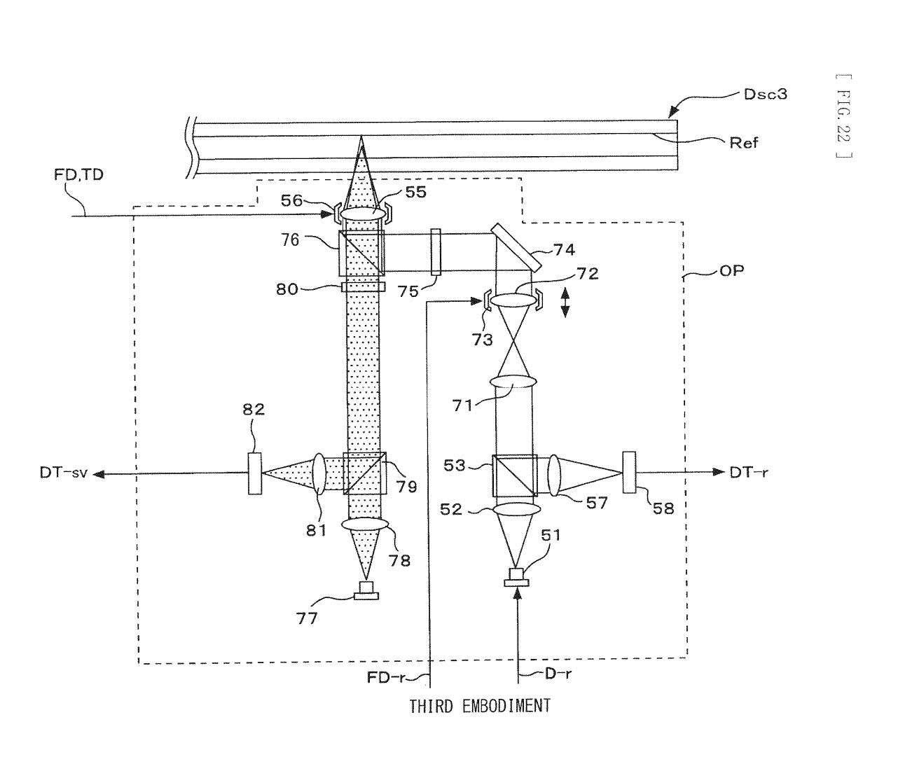

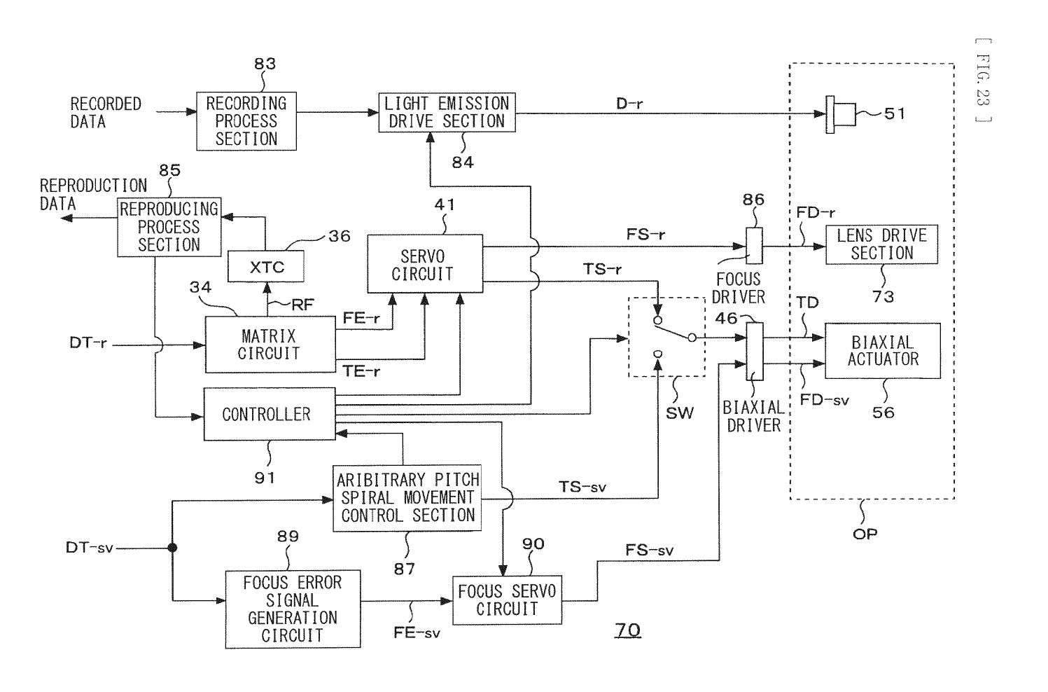

Referring to FIGS. 22 and 23, description will be provided of a configuration of the recording-reproducing device 70 that performs recording and reproducing operation in accordance with the multi-layered recording medium Dsc3.

FIG. 22 is a diagram for mainly explaining a configuration of an optical system included in the recording-reproducing device 70.

Specifically, FIG. 22 mainly shows an internal configuration of an optical pick-up OP included in the recording-reproducing device 70 in the third embodiment.

In FIG. 22, the multi-layered recording medium Dsc3 loaded in the recording-reproducing device 70 is set so that a center hole thereof be clamped at a predetermined position in the recording-reproducing device 70. The multi-layered recording medium Dsc3 is held in a state in which the multi-layered recording medium Dsc3 is allowed to be driven to rotate by an unillustrated spindle motor.

The optical pick-up OP is provided in order to irradiate the recording-layer laser light or the servo laser light with respect to the multi-layered recording medium Dsc3 that is driven to rotate by the above-described spindle motor.

A recording-layer laser 51 and a servo laser 77 are provided in the optical pick-up OP. The recording-layer laser 51 is a light source of the recording-layer laser light for performing information recording operation by a mark, reproducing operation of information recorded by a mark. The servo laser 77 is a light source of the servo laser light that is light for performing position control utilizing the position guide formed in the reference surface Ref.

Here, as described above, the recording-layer laser light and the servo laser light have wavelength bands different from each other. As described above, in the case of the present example, the wavelength of the recording-layer laser light is about 405 nm (a so-called blue-violet laser light), and the wavelength of the servo laser light is about 650 nm (red laser light).

Also, the objective lens 55 is provided in the optical pick-up OP. The objective lens 55 is to be an output terminal of the recording-layer laser light and the servo laser light with respect to the multi-layered recording medium Dsc3.

Further, there are provided a recording-layer light receiving section 58 and a servo-light light receiving section 82. The recording-layer light receiving section 58 is for receiving reflected light of the recording-layer laser light from the multi-layered recording medium Dsc3. The servo-light light receiving section 82 is for receiving reflected light of the servo laser light from the multi-layered recording medium Dsc3.

Moreover, in the optical pick-up OP, there is formed an optical system for guiding the recording-layer laser light emitted from the recording-layer laser 51 to the objective lens 55, and for guiding the reflected light of the recording-layer laser light from the multi-layered recording disc Dsc3 that has entered the objective lens 55 to the recording-layer light receiving section 58.

Specifically, the recording-layer laser light emitted from the recording-layer laser 51 is allowed to be parallel light via the collimator lens 52, and then, enters the polarizing beam splitter 53. The polarizing beam splitter 53 is configured to transmit the recording-layer laser light that has entered from the recording-layer laser 51 side in such a manner.

The recording-layer laser light that has passed through the polarizing beam splitter 53 enters a focusing mechanism configured including a fixed lens 71, a movable lens 72, and a lens drive section 73. This focusing mechanism is provided for adjusting a focus position of the recording-layer laser light. A lens closer to the recording-layer laser 51 serving as a light source is set as the fixed lens 71. The movable lens 72 is arranged farther from the recording-layer laser 51. The focusing mechanism is configured so that the movable lens 72 side is driven by the lens drive section 73 in a direction parallel to an optical axis of the recording-layer laser light.

The recording-layer laser light that has passed through the fixed lens 71 and the movable lens 72 forming the above-described focusing mechanism is reflected by a mirror 74 as shown in the drawing. Thereafter, the reflected recording-layer laser light enters a dichroic prism 76 via a ¼ wavelength plate 75.

The dichroic prism 76 has a selective reflection surface that is configured to reflect light having a wavelength band same as that of the recording-layer laser light, and to transmit light having other wavelength. Therefore, the recording-layer laser light that has entered as described above is reflected by the dichroic prism 76.

The recording-layer laser light reflected by the dichroic prism 76 is irradiated with respect to the multi-layered recording medium Dsc3 (the desirable semitransparent recording film 61) via the objective lens 55 as illustrated.

For the objective lens 55, there is provided the biaxial actuator 56 that holds the objective lens 55 to be allowed to be displaced in a focusing direction (a direction closer or away from the multi-layered recording medium Dsc3) or in a tracking direction (a direction orthogonal to the above-described focusing direction: a disc radial direction).

The biaxial actuator 56 includes a focusing coil and a tracking coil. Drive signals (drive signals FD and TD which will be described later) are provided to the respective focusing and tracking coils, and thereby, the objective lens 20 is displaced in the respective focusing and tracking directions.

Here, at the time of reproducing operation, the recording-layer laser light is irradiated with respect to the multi-layered recording medium Dsc3 as described above. In accordance therewith, reflected light of the recording-layer laser light is obtained by the multi-layered recording medium Dsc3 (the semitransparent recording film 61 targeted for reproducing operation). The thus-obtained reflected light of recording-layer laser light is guided to the dichroic prism 76 via the objective lens 55, and is reflected by the dichroic prism 76.

The reflected light of the recording-layer laser light that has been reflected by the dichroic prism 76 enters the polarizing beam splitter 53 after passing through the ¼ wavelength plate 75→the mirror 74→the focusing mechanism (the movable lens 72→the fixed lens 71).

The reflected light of the recording-layer laser light that enters the polarizing beam splitter 53 in such a manner passes through the ¼ wavelength plate 75 for an outward path and a returning path. Therefore, a polarization direction thereof is rotated by 90°. As a result, the reflected light of the recording-layer laser light that has entered as described above is reflected by the polarizing beam splitter 53.

The reflected light of the recording-layer laser light that has been reflected by the polarizing beam splitter 53 is condensed on a light receiving surface of the recording-layer light receiving section 58 via the condensing lens 57.

Also, in the optical pick-up OP, there is formed an optical system for guiding the servo laser light emitted from the servo laser 77 to the objective lens 55, and for guiding the reflected light of the servo laser light from the multi-layered recording medium Dsc3 that has entered the objective lens 55 to the servo-light light receiving section 82.

As described above, the servo laser light emitted from the servo laser 77 is allowed to be parallel light via a collimator lens 78, and then, enters a polarizing beam splitter 79. The polarizing beam splitter 79 is configured to transmit the servo laser light (outward-path light) that has entered from the servo laser 77 side in such a manner.

The servo laser light that has passed through the polarizing beam splitter 79 enters the dichroic prism 76 via the ¼ wavelength plate 80.

As described before, the dichroic prism 76 is configured to reflect light having a wavelength band same as that of the recording-layer laser light, and to transmit light having a wavelength other than that. Therefore, the servo laser light passes through the dichroic prism 76, and is irradiated to the multi-layered recording medium Dsc3 via the objective lens 55.

Moreover, the reflected light (the reflected light from the reference surface Ref) of the servo laser light obtained in accordance with irradiation of the servo laser light to the multi-layered recording medium Dsc3 in such a manner passes through the dichroic prism 76 after passing through the objective lens 55, and enters the polarizing beam splitter 79 via the ¼ wavelength plate 80.

As in the above-described case of the recording laser light, the reflected light of the servo laser light that has entered from the multi-layered recording medium Dsc3 side in such a manner passes through the ¼ wavelength plate 80 twice for an outward path and a returning path. Therefore, a polarization direction thereof is rotated by 90°. Therefore, the above-described reflected light of the servo laser light is reflected by the polarizing beam splitter 79.

The reflected light of the servo laser light that has been reflected by the polarizing beam splitter 79 is condensed on a light receiving surface of the servo-light light receiving section 82 via the light condensing lens 81.

It is to be noted that, although explanation by illustrating is omitted, actually, the recording-reproducing device 70 includes a slide drive section that drives the above-described optical pick-up OP as a whole to slide in the tracking direction. It is possible to displace an irradiation position of the laser light in a wide range by driving the optical pick-up OP by the slide drive section.

Here, the multi-layered recording medium Dsc3 has the reference surface Ref on the lower layer side of the recording layer 63 as described before. Therefore, at the time of recording, focus servo control of the objective lens 55 is performed so that the servo laser light focus on the reference surface Ref provided on the lower layer side of the recording layer 63 in such a manner. Also, concerning the recording-layer laser light, by driving the above-described focusing mechanism (the lens drive section 73) by performing focus servo control based on the reflected light of the recording-layer laser light, the collimation state of the recording-layer laser light entering the objective lens 55 is adjusted so that the recording-layer laser light focus in the recording layer 63 formed on the upper layer side of the reference surface Ref.

Moreover, tracking servo control of the recording-layer laser light at the time of reproducing operation is allowed to be performed based on the mark line formed in the semitransparent recording film 61 targeted for reproducing. In other words, the tracking servo control of the recording-layer laser light at the time of reproducing operation is allowed to be achieved by controlling the position of the objective lens 55 based on the reflected light of the recording-layer laser light.

It is to be noted that the focus servo control at the time of reproducing operation may be similar to that at the time of recording operation.

FIG. 23 shows an internal configuration example of the entire recording-reproducing device 70 of the third embodiment.

It is to be noted that FIG. 23 extracts and shows only the recording-layer laser 51, the lens drive section 73, and the biaxial actuator 56 out of the configuration shown in FIG. 22 for the internal configuration of the optical pick-up OP.

In FIG. 23, outside of the optical pick-up OP of the recording-reproducing device 70, there is provided a recording process section 83, a light emission drive section 84, the matrix circuit 34, the cross-talk cancel circuit 36, a reproducing process section 85, the servo circuit 41, a focus driver 86, and the biaxial driver 46, as a configuration for performing recording/reproducing operation targeting the recording layer 63 in the multi-layered recording medium Dsc3, position control of the focusing/tracking based on the reflected light from the semitransparent recording film 61 formed in the recording layer 63, etc.

The recording process section 83 generates a recording modulation code in accordance with the input recorded data. Specifically, the recording process section 83 may perform, for example, addition of an error correction code to the input recorded data or a predetermined recording modulation coding process. Thus, a recording modulation code string that may be, for example, a binary data string of “0” and “1” to be actually recorded targeting the recording layer 63 is obtained.

The recording process section 83 supplies a recorded signal based on the recording modulation code string generated in such a manner to the light emission drive section 84.

Here, in the present embodiment, single spiral recording operation is performed in a manner similar to that in the case of the above-described first embodiment. Therefore, at the time of reproducing operation, it is necessary to switch tracking servo operation (to perform the tracking servo operation in different manners) for every rotation angle θ_{R}.

In the case of the present example, detection of such a rotation angle θ_{R} at the time of reproducing operation is performed by recording in advance the marker information representing the rotation angle θ_{R} in the recording layer 63 (the semitransparent film 61), and obtaining the marker information from a reproduction signal.

Therefore, the recording process section 83 in this case also performs an insertion process of the marker information.

At the time of recording operation, the light emission drive section 84 generates a laser drive signal D-r based on a recorded signal input from the recording process section 83, and drives the recording-layer laser 51 to emit light based on the drive signal D-r.

Here, the light emission drive section 84 is configured to be capable of performing, in a switching manner, generation of a recorded signal for achieving a state where the groove G is inserted between the marks, and generation of a recorded signal for achieving a state where the groove G is not inserted between the marks, in accordance with the instruction from a later-described controller 91, so that the grooved tracks T-g and the no-groove tracks T-s are arranged alternately in the radial direction.

Also, at the time of reproducing operation, the light emission drive section 84 allows the recording-layer laser 51 to emit light with reproducing power based on the instruction from the controller 91.

The matrix circuit 34 in this case generates the RF signal, a focus error signal FE-r, a tracking error signal TE-r based on light reception signals DT-sp (output currents) from a plurality of light receiving elements as the recording-layer light receiving section 58 illustrated in FIG. 22 described above.

It is to be noted that, as can be understood from the above description, the focus error signal FE-r is utilized at both the times of recording operation and reproducing operation.

On the other hand, the tracking error signal TE-r is utilized only at the time of reproducing operation.

These focus error signal FE-r and the tracking error signal TE-r are supplied to the servo circuit 41.

Moreover, the RF signal obtained in the matrix circuit 34 is subjected to a cross-talk cancel process in the cross-talk cancel circuit 36, and thereafter, is supplied to the reproducing process section 85.

The reproducing process section 85 corresponds to combination of the data detection process section 35 and the process section related to reproducing operation in the encoding/decoding section 37 described above in FIG. 10. Specifically, the reproducing process section 85 at least generates a binary data string based on the PRML detection method, performs a decoding process of reproduction data from the binary data string, and generates a clock.

Here, the binary data string obtained in the reproducing process section 85 is supplied to the controller 91 for detecting the marker information representing the rotation angle θ_{R}.

The servo circuit 41 generates the focus servo signal FS-r based on the focus error signal FE-r in a manner similar to that of the servo circuit 41 shown in FIG. 10. Also, the servo circuit 41 performs a process for generating the tracking servo signal TS-r for allowing performing tracking servo operation in different manners between the grooved track T-g and the no-groove track T-c as the tracking servo signal TS-r at the time of reproducing.

Specifically, in accordance with the instruction from the controller 91 in accordance with the time of reproducing operation, the servo circuit 41 performs, in a switching manner, generation of the tracking servo signal TS-r based on the signal obtained by performing polarity inversion or offset on the tracking error signal TE-r, and generation of the tracking error signal TE-r itself (the tracking error signal TE-r without being subjected to the above-described polarity inversion or the above-described offset).

The focus servo signal FS-r generated in the servo circuit 41 is supplied to the focus driver 86. The focus driver 86 generates a focus drive signal FD-r based on the focus servo signal FS-r, and drives the lens drive section 73 based on the focus drive signal FD-r.

Thus, focus servo control for the recording-layer laser light is achieved.

Moreover, the tracking servo signal TS-r generated in the servo circuit 41 is supplied to a switch SW which will be described later.

Moreover, in the recording-reproducing device 70, there is provided an arbitrary pitch spiral movement control section 87, a focus error signal generation circuit 89, and a focus servo circuit 90, as a signal process system for the reflected light of the servo laser light.

The arbitrary pitch spiral movement control section 87 generates a tracking servo signal TS-sv for achieving the arbitrary pitch spiral movement described above referring to FIGS. 19 to 21 based on the light reception signal DT-sv from a plurality of light receiving elements as the servo-light light receiving section 82 shown in FIG. 22.

It is to be noted that a specific configuration of the arbitrary pitch spiral movement control section 87 for achieving the arbitrary pitch spiral movement in such a manner is disclosed in Reference Literatures 5 or 6 mentioned above, and therefore, description thereof is omitted here.

As can be understood from the above description, in the case of the present example, the arbitrary pitch spiral movement control section 87 is configured to achieve spiral movement at a pitch of 0.22 μm.

The tracking servo signal TS-sv obtained by the arbitrary pitch spiral movement control section 87 is supplied to the switch SW.

Here, the switch SW is provided related to position control in the tracking direction of the objective lens 55. The switch SW is provided to allow position control based on the tracking servo signal TS-sv obtained in the arbitrary pitch spiral movement control section 87 to be executed at the time of recording operation, and is provided to allow position control based on the tracking servo signal TS-r obtained in the servo circuit 41 to be executed at the time of reproducing operation.

Specifically, the switch SW selectively outputs the tracking servo signal TS-sv in accordance with the instruction made by the controller 91 in correspondence with the time of recording operation.

Further, the switch SW selectively outputs the tracking servo signal TS-r in accordance with the instruction made by the controller 91 in correspondence with the time of reproducing operation.

Thus, it is possible to achieve switching between the tracking servo control as the arbitrary pitch spiral movement control in correspondence with the time of recording operation and the tracking servo control based on the reflected light of the recording-layer laser light in accordance with the time of reproducing operation.

The tracking servo signal TS selectively outputted from the switch SW is supplied to the biaxial driver 46 which will be described later.

Moreover, the focus error signal generation circuit 89 generates the focus error signal FE-sv based on the light reception signal DT-sv from the servo-light light receiving section 82. The focus servo circuit 90 performs a filter process, on the focus error signal FE-sv, for generating a servo signal, and generates the focus servo signal FS-sv.

The focus servo signal FS-sv obtained by the focus servo circuit 90 is supplied to the biaxial driver 46.

The biaxial driver 46 generates a tracking drive signal TD and a focus drive signal FD-sv based on the tracking servo signal TS-sv supplied from the switch SW and the focus servo signal FS-sv supplied from the focus servo circuit 90, respectively. The biaxial driver 46 drives the tracking coil and the focusing coil of the biaxial actuator 56 based on these drive signals.

The controller 91 may be configured, for example, of a microcomputer. The controller 91 may perform overall control of the recording-reproducing device 70, for example, by executing control and processes in accordance with a program stored in a built-in ROM, etc.

For example, the controller 91 may perform a process for performing switching in correspondence with the time of recording operation/the time of reproducing operation, related to the tracking servo control of the objective lens 55. Specifically, the controller 91 allows the switch SW to select the tracking servo signal TS-sv in correspondence with the time of recording operation, and allows the tracking servo control to be performed for achieving the arbitrary pitch spiral movement described above. Further, in correspondence with the time of reproducing operation, the controller 91 allows the switch SW to select the tracking servo signal TS-r and allows the tracking servo control to be executed based on the reflected light of the recording-layer laser light.

Moreover, based on the detection process result of the rotation angle θ_{R}, the controller 91 performs a process for achieving switching between recording operation of the grooved track T-g/recording operation of the no-groove track T-s at the time of recording operation, and performs a process for achieving tracking servo operation in different manners at the time of reproducing.

Here, as can be understood from the above description, in the present example, the detection of the rotation angle θ_{R} at the time of recording operation is performed by detecting the marker information recorded in the reference surface Ref. Also, the detection of the rotation angle θ_{R} at the time of reproducing operation is performed by detecting the marker information recorded in the recording layer 63 (the semitransparent recording film 61 targeted for reproducing operation).

At the time of recording operation, the controller 91 performs detection of the above-described marker information from the reproduction signal for the servo-targeted pit line inputted from the arbitrary pitch spiral movement control section 87. Based on that result, the controller 91 instructs the recording process section 83 to perform switching between recording operation of the grooved track T-g/recording operation of the no-groove track T-s for every rotation angle θ_{R}.

It is to be noted for conformation, as can be seen referring to the above-described Reference Literatures 5 and 6, the arbitrary pitch spiral movement control section 87 is configured to obtain a reproduction signal for the servo-targeted pit line for reading the address information recorded in the reference surface Ref.

Moreover, at the time of reproducing operation, detection of the above-described maker information from a binary data string inputted from the reproducing process section 85 is performed. Based on that result, instruction provided to the servo circuit 41 for performing switching for performing the tracking servo operation in different manners.

With the use of the above-described recording-reproducing device 70, it is possible to perform recording operation with respect to the multi-layered recording medium Dsc3 as a recordable-type optical disc so that the grooved tracks (mark lines) T-g and the no-groove tracks (mark lines) T-s be arranged alternately in the radial direction at a track pitch of 0.27 μm or smaller. Moreover, according to the recording-reproducing device 70, it is possible to appropriately perform tracking servo operation in accordance with the multi-layered recording medium Dsc3 in which the tracks T are arranged at a pitch out of the optical limit value in such a manner.

In such a manner, also according to the third embodiment, it is possible to achieve an optical disc system that allows tracking servo operation to be performed appropriately under a state where the tracks T are arranged at a pitch out of the optical limit value. Accordingly, as a result, it is possible to further improve information recording density and further expand the recording capacity.

### 5. Fourth Embodiment

### Method of Eliminating Necessity of Arbitrary Pitch Spiral Movement Control

A fourth embodiment proposes a method to allow the arbitrary pitch spiral movement control as in the third embodiment to be unnecessary in a case of performing, as in the third embodiment, recording operation targeting a recordable-type optical disc in which the position guide in the recording layer 63 is omitted by performing position control utilizing the position guide formed in the reference surface Ref.

Hereinafter, in such a fourth embodiment, there are proposed two methods that are a first method and a second method.

[5-1. First Method]

First, as a premise, there is used a recordable-type optical disc in which the position guides formed on the reference surface Ref are grooves, and the grooves are formed at a track pitch which is not out of the optical limit value in the reference surface Ref, in the fourth embodiment.

Specifically, in the fourth embodiment, compared with the multi-layered recording medium Dsc3 used in the third embodiment, there is used an optical disc recording medium in which the above-described change is applied to the structure of the reference surface Ref, and other structure is similar to that in the third embodiment.

Hereinafter, such an optical disc recording medium used in the fourth embodiment is described as “multi-layered recording medium Dsc4”.

However, as described above, in a case where the track pitch on the reference surface Ref is set in a range not out of the optical limit value, it is not possible to arrange mark lines formed in the recording layer 63 at a track pitch Tp out of the optical limit value in the recording layer 63, by only and simply performing the servo control in accordance with the tracks on the reference surface Ref.

Accordingly, a recording method is adopted in consideration of this point.

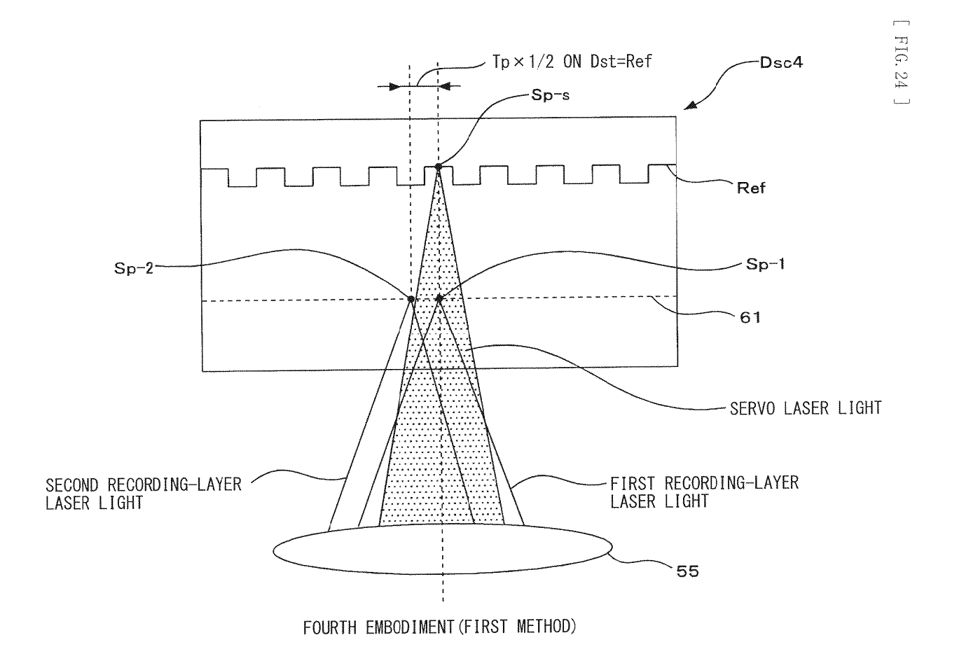

FIG. 24 is a diagram for explaining the first method of the fourth embodiment.

FIG. 24 schematically illustrates a relationship between an outline cross-sectional structure of the multi-layered recording medium Dsc4 (extracting and showing only the reference surface Ref and the semitransparent recording film 61 in the recording layer 63) and each laser light irradiated to the multi-layered recording medium Dsc4 via the objective lens 55.

As can be seen referring to this FIG. 24, in the fourth embodiment, two laser lights that are first recording-layer laser light and second-recording layer laser light are irradiated as the recording-layer laser light.

In the case of the present example, the first recording-layer laser light is for recording operation of the grooved track T-g, and the second recording-layer laser light is for recording operation of the no-groove track T-s.

Here, the beam spots of these first recording-layer laser light and second recording-layer laser light formed on the semitransparent recording film 61 targeted for recording operation are represented as a first spot Sp-1 and a second spot Sp-2, respectively, as shown in the drawing. In the first method, a spacing Dst in the radial direction between the first spot Sp-1 and the second spot Sp-2 is set to ½ of the track pitch on the reference surface Ref.

Further, in the first method, tracking servo control at the time of recording operation is performed by controlling the position of the objective lens 55 so that the beam spot (described as “servo light spot Sp-s” as in the drawing) of the servo laser light trace the grooves on the reference surface Ref based on the reflected light of the servo laser light.

In the first method, under a state where such setting of the spot spacing Dst and such tracking servo control are performed, recording operation of the grooved tracks T-g with the use of the first recording-layer laser light and recording operation of the no-groove track T-s with the use of the second recording-layer laser light are performed in parallel at the same time.

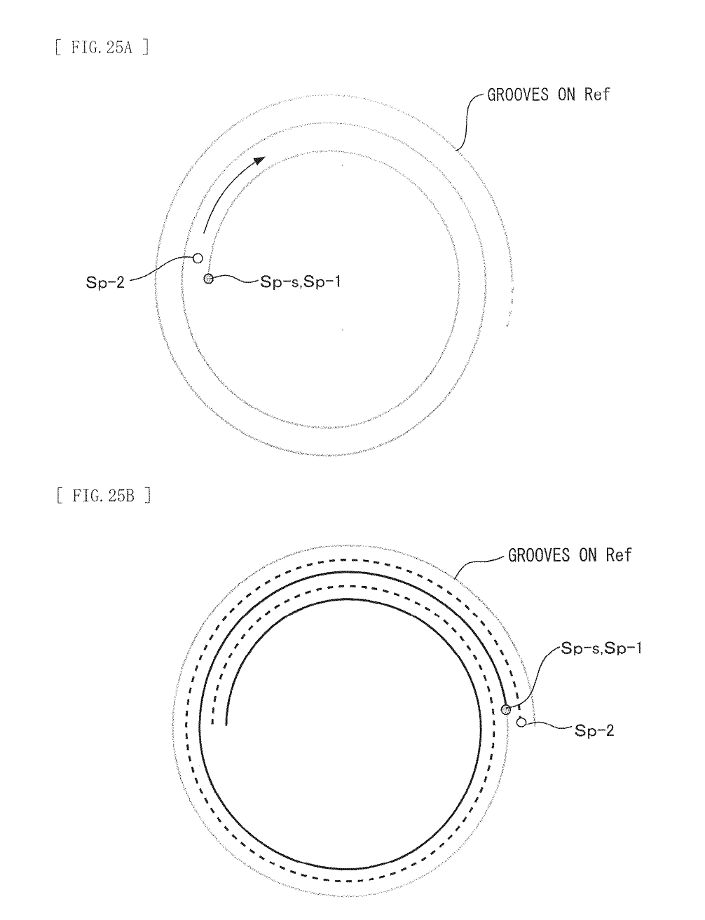

For confirmation, FIGS. 25A and 25B each show a state in a case where recording operation is performed by such a first method.

It is to be noted that, in FIGS. 25A and 25B, a gray line represents grooves on the reference surface Ref, and a black line represents tracks T (a solid line represents the grooved tracks T-g, and a dashed line represents the no-groove tracks T-s) recorded in the semitransparent recording film 61.

First, it is to be noted for confirmation that, in this case, one of the two recording-layer laser lights is irradiated to the multi-layered recording medium Dsc4 so that an optical axis thereof coincide with that of the servo laser light. In the present example, the first recording-layer laser light is assumed to have an optical axis that coincides with the optical axis of the servo laser light.

As described above, at the time of recording operation in this case, tracking servo control is performed for the objective lens 55 so that the servo light spot Sp-s be allowed to follow the grooves on the reference surface Ref. (See FIG. 25A.)

Further, under such tracking servo control, recording operation of the grooved tracks T-g with the use of the first recording-layer laser light (the first spot Sp-1) and recording operation of the no-groove tracks T-s with the use of the second recording-layer laser light (the second spot Sp-2) are performed at the same time. Accordingly, the tracks T are formed in the semitransparent recording film 61 targeted for recording as shown by the black line in FIG. 25B. Specifically, in this case, recording operation is performed so that the tracks T be arranged at a pitch that is ½ of the track pitch (the pitch represented by the gray line in the drawing) in the reference surface Ref.

According to the first method as described above, it is possible to arrange the grooved tracks T-g and the no-groove tracks T-s at the track pitch Tp that is ½ of the track pitch in the reference Ref, in the semitransparent recording film 61 targeted for recording operation.

For example, in a case where the track pitch in the reference surface Ref is allowed to be about 0.500 μm (an optical condition that allows the optical limit value in the reference surface Ref is to be 0.500 μm is set), the track pitch Tp in the semitransparent recording film 61 is allowed to be set to about 0.25 μm which is half thereof. Accordingly, it is possible to achieve the optical disc recording medium of the present technology.

It is to be noted that, in the above description, tracking servo control of the objective lens 55 is performed so that the servo light spot Sp-2 follow the grooves in the reference surface Ref. However, it goes without saying that a similar result is obtainable also in a case where tracking servo control is performed so that the servo light spot Sp-2 follow the land zones in the reference surface Ref.

Moreover, in the above description, the case in which the groove is formed as the position guide in the reference surface Ref has been exemplified. However, the position guide in the reference surface Ref may be configured of a pit line or a mark line.

Here, according to the above-described first method, in the recording layer 63, double spiral recording operation as in the second embodiment is performed. Therefore, at the time of reproducing the mark line recorded in the recording layer 63, it is not necessary to perform tracking servo operation in different manners as in the first and third embodiments if reproducing operation is performed with the use of two beams as in the second embodiment.

Specifically, reproducing operation in this case may be performed with the use of the first recording-layer laser light (serving as first reproducing laser light for reproducing the grooved track T-g) and the second recording-layer laser light (serving as second reproducing laser light for reproducing the no-groove track T-s). Thus, by performing position control of the objective lens 55 in accordance with the tracking error signal TE generated based on the reflected light of the first recording-layer laser light, the first and second recording-layer laser lights are allowed to follow the grooved tracks T-g and the no-groove tracks T-s, respectively. Accordingly, it is possible to read the recorded information of the grooved tracks T-g and the no-groove tracks T-s at the same time.

[5-2. Configuration of Recording-Reproducing Device]

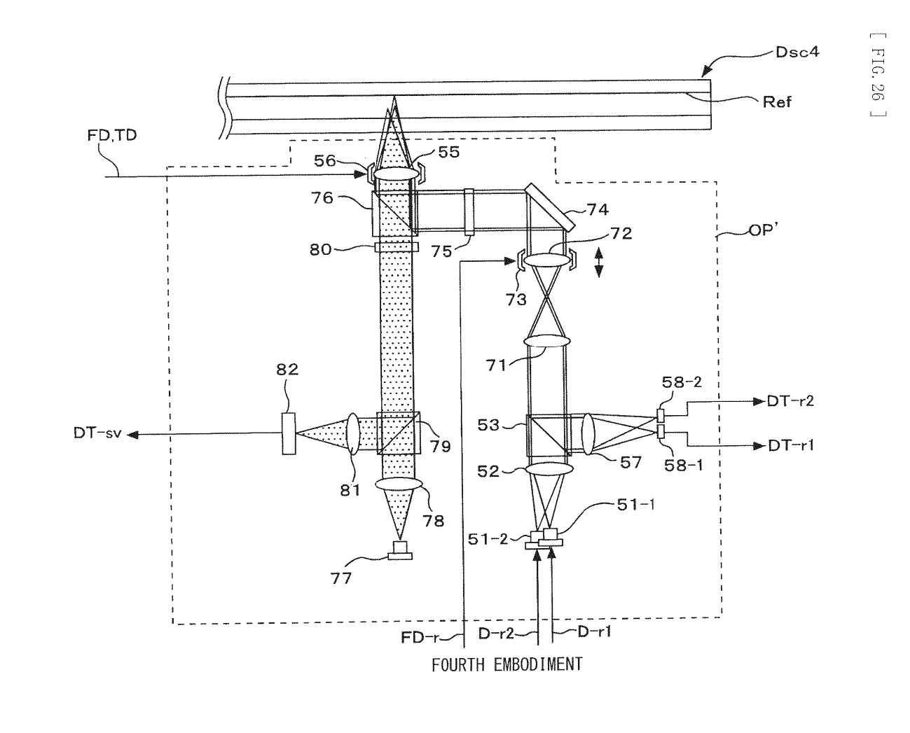

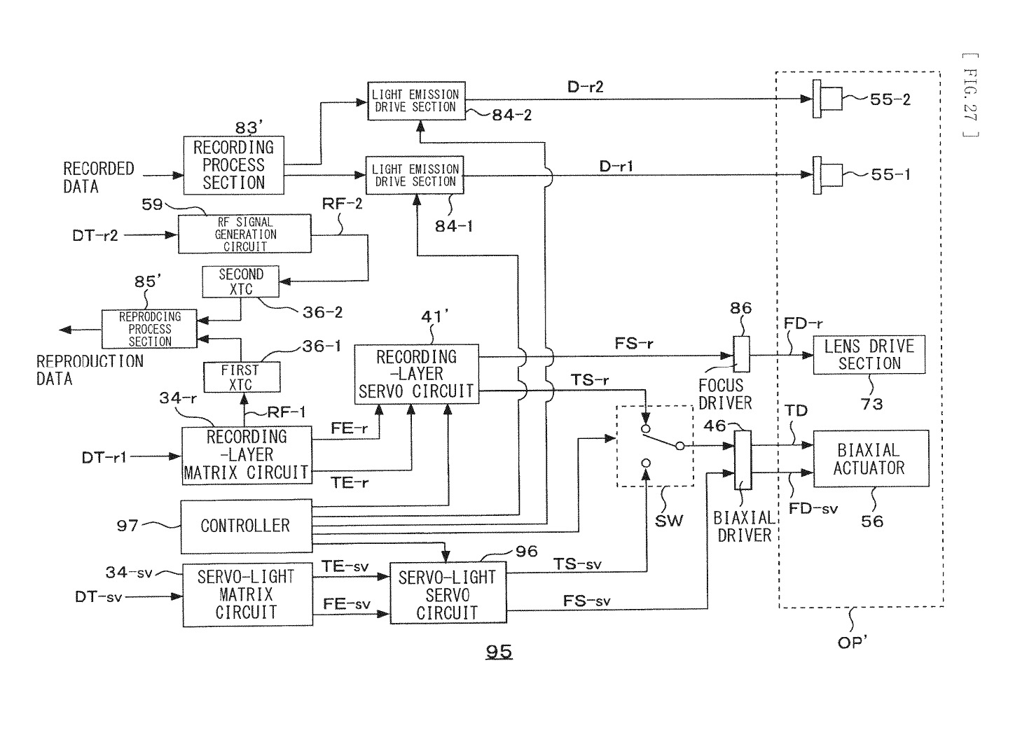

Referring to FIGS. 26 and 27, description will be provided of a configuration of a recording-reproducing device 95 for achieving a recording-reproducing operation in the first method described above.

FIG. 26 is a diagram for mainly explaining a configuration of an optical system included in the recording-reproducing device 95. Specifically, FIG. 26 mainly shows an internal configuration example of an optical pick-up OP′ included in the recording-reproducing device 95.

As can be seen by comparing to FIG. 22 described above, the optical pick-up OP′ in this case is different from the optical pick-up OP in the case of the third embodiment in comparison, in that two lasers that are a first recording-layer laser 51-1 to be the light source of the first recording-layer laser light and a second recording-layer laser 51-2 to be the light source of the second recording-layer laser light are provided as the recording-layer laser 51, and in that a first recording-layer light receiving section 58-1 receiving reflected light of the first recording-layer laser light and a second recording-layer light receiving section 58-2 receiving reflected light of the second recording-layer laser light are provided as the recording-layer light receiving section 58.

As can be understood from the above description, the optical pick-up OP′ (the optical system) in this case is designed so that the spot spacing Dst between the first spot Sp-1 of the first recording-layer laser light and the second spot Sp-2 of the second recording-layer laser light be ½ of the track pitch in the reference surface Ref.

Moreover, the first recording-layer light receiving section 58-1 includes a division detector, and is configured to divisionally receive the reflected light of the first recording-layer laser light so that generation of the tracking error signal TE-r based on the reflected light of the first recording-layer laser light be allowed to be performed at the time of reproducing as described before.

FIG. 27 shows an internal configuration example of the entire recording-reproducing device 95.

It is to be noted that, concerning the internal configuration of the optical pick-up OP′, FIG. 27 extracts and shows only the first recording-layer laser 51-1, the second recording-layer laser 51-2, the lens drive section 73, and the biaxial actuator 56 out of the configuration shown in FIG. 26.

As can be seen from comparison to FIG. 23 described before, the recording-reproducing device 95 in this case is different from the recording-reproducing device 70 in the third embodiment in comparison in that, concerning a configuration of the outside of the optical pick-up OP′, a recording process section 83′ is provided instead of the recording process section 83, in that a light emission drive section 84-1 and a light emission drive section 84-2 are provided as the light emission drive section 84, in that a recording-layer matrix circuit 34-r is provided instead of the matrix circuit 34, in that an RF signal generation circuit 59 is newly provided, in that a cross-talk cancel circuit 36-1 and a cross-talk cancel circuit 36-2 are provided as the cross-talk cancel circuit 36, in that a reproducing process section 85′ is provided instead of the reproducing process section 85, in that a recording-layer servo circuit 41′ is provided instead of the servo circuit 41, and in that a servo-light matrix circuit 34-sv and a servo-light servo circuit 96 are provided instead of the arbitrary pitch spiral movement control section 87, the focus error signal generation circuit 89, and the focus servo circuit 90.

The recording process section 83′ divides the input recorded data into two systems and generates a recorded signal based on one of the divided data and generates a recorded signal based on the other as with the recording waveform generation section 3′ in the case of the second embodiment.

In the case of the present example as described before, the first recording-layer laser light side is used for recording operation of the grooved track T-g, and the second recording-layer laser light side is used for recording operation of the no-groove track T-s. Therefore, the recording process section 83′ in this case generates a signal that is capable of inserting the groove G between the marks in accordance with the input recorded data as the recorded signal to be supplied to the light emission drive section 84-1 side.

It is to be noted that, also in this case, as a method of dividing the recorded data, for example, a method of distributing recorded data to the light emission drive section 84-1 side and the light emission drive section 84-2 side on a predetermined data unit basis, etc. may be mentioned.

The light emission drive section 84-1 and the light emission drive section 84-2 generates a laser drive signal D-r1 and a laser drive signal D-r2 in accordance with the recorded signal supplied from the recording process section 83′, respectively. The light emission drive section 84-1 and the light emission drive section 84-2 thus drive the first recording-layer laser 55-1 and the second recording-layer laser 55-2 in the optical pick-up OP′ to emit light based on those drive signals, respectively.

Moreover, these light emission drive sections 84-1 and 84-2 drive the first recording-layer laser 55-1 and the second recording-layer laser 55-2 to emit light with reproducing power in accordance with the instruction made in correspondence with the time of reproducing from a controller 97 which will be described later, respectively.

The recording-layer matrix circuit 34-r generates the RF signal, the focus error signal FE-r, and the tracking error signal TE-r as with the matrix circuit 34 described before based on the light reception signal DT-r1 from a plurality of light receiving elements as the first recording-layer light receiving section 58-1.

Here, in order to differentiate from the RF signal generated based on the reflected light of the second recording-layer laser light, the RF signal generated by the first recording-layer matrix circuit 34-r is described hereinafter as “first reproduction information signal RF-1”.

The focus error signal FE-r and the tracking error signal TE-r obtained by the recording-layer matrix circuit 34-r are supplied to the recording-layer servo circuit 41′.

The first reproduction information signal RF-1 obtained by the recording-layer matrix circuit 34-r is subjected to a cross-talk cancel process by the first cross-talk cancel circuit 36-1, and is supplied to the reproducing process section 85′.

Moreover, the RF signal generation circuit 59 generates an RF signal (hereinafter, represented as “second reproduction information signal RF-2”) based on the light reception signal DT-r2 obtained by the second recording-layer light receiving section 58-2.

The second reproduction information signal RF-2 obtained by the RF signal generation circuit 59 is subjected to a cross-talk cancel process by the second cross-talk cancel circuit 36-2, and is supplied to the reproducing process section 85′.

The reproducing process section 85′ performs processes such as a binarization process and a predetermined decoding process on the first reproduction information signal RF-1 and the second reproduction information signal RF-2 that have been subjected to the cross-talk cancel process, and thereby, obtains reproduction data.

The recording-layer servo circuit 41′ performs a filter process for generating a servo signal on the focus error signal FE-r and the tracking error signal TE-r, and generates the focus servo signal FS-r and the tracking servo signal TS-r, respectively.

The focus servo signal FS-r is supplied to the focus driver 86, and the tracking servo signal TS-r is supplied to the switch SW.

The focus driver 86 drives the lens drive section 73 with the use of the focus drive signal FD-r generated based on the focus servo signal FS-r. Accordingly, focus servo control is performed so that the first recording-layer laser light and the second recording-layer laser light focus on the semitransparent recording film 61 targeted for recording/reproducing operation.

Moreover, concerning the signal process system on the servo laser light side, the servo-light matrix circuit 34-sv generates the focus error signal FE-sv based on the reflected light of the servo laser light, and the tracking error signal TE-sv, based on the light reception signal DT-sv from the plurality of light receiving elements as the servo-light light receiving section 82.

The servo-light servo circuit 96 performs a filter process for generating a servo signal on the focus error signal FE-sv and the tracking error signal TE-sv, and generates the focus servo signal FS-sv and the tracking servo signal TS-sv.

As in the drawing, the focus servo signal FS-sv is supplied to the biaxial driver 46, and the tracking servo signal TS-sv is supplied to the switch SW.

The switch SW selectively outputs, to the biaxial driver 46, one of the tracking servo signal TS-r inputted from the recording-layer servo circuit 41′ side and the tracking servo signal TS-sv inputted from the servo-light servo circuit 96 side, based on the instruction from the controller 97.

As can be understood from the above description, tracking servo control of the objective lens 55 is performed based on the reflected light (that is, the reflected light from the reference surface Ref) of the servo laser light at the time of recording operation and is performed based on the reflected light of the first recording-layer laser light at the time of reproducing operation. Accordingly, the switch SW selectively outputs the tracking servo signal TS-sv in correspondence with the time of recording operation, and selectively outputs the tracking servo signal TS-r in correspondence with the time of reproducing operation, based on the instruction from the controller 97.

The biaxial driver 46 drives the focusing coil and the tracking coil of the biaxial actuator 56 based on the focus drive signal FD-sv and the tracking drive signal TD generated from the focus servo signal FS-sv and the tracking servo signal TS that is inputted from the switch SW, respectively.

Accordingly, focus servo control for the objective lens 55 and tracking servo control are achieved.

The controller 97 may be configured, for example, of a microcomputer. The controller 97 executes control and processes in accordance with the program stored in a built-in ROM, etc., and thereby controls the entire recording-reproducing device 95.

In particular, the controller 97 in this case performs a process for performing switching in correspondence with the time of recording operation/the time of reproducing operation related to the tracking servo control of the objective lens 55. Specifically, in correspondence with the time of reproducing operation, the controller 97 allows the switch SW to select the tracking servo signal TS-sv, and to allow tracking servo control of the objective lens 55 based on the reflected light from the reference surface Ref to be performed. Further, in correspondence with the time of reproducing operation, the controller 97 allows the switch SW to select the tracking servo signal TS-r and to allow the tracking servo control based on the reflected light of the first recording-layer laser light to be executed.

By such a recording-reproducing device 95, it is possible to perform recording operation with respect to the multi-layered recording medium Dsc4 as a recordable-type optical disc so that the grooved tracks (mark lines) T-g and the no-groove tracks (mark lines) T-s be arranged alternately in the radial direction at a track pitch of 0.27 μm or smaller. Further, according to the recording-reproducing device 95, it is possible to appropriately perform tracking servo operation in correspondence with the multi-layered recording medium Dsc4 in which the tracks T are arranged at a pitch out of the optical limit value in such a manner.

In such a manner, also according to the fourth embodiment, it is possible to achieve an optical disc system that allows tracking servo operation to be performed appropriately under a state where the tracks T are arranged at a pitch out of the optical limit value. As a result, it is possible to further improve information recording density and to further expand recording capacity.

[5-3. Second Method]

Here, as described above, when the optical conditions of the reference surface Ref are set to conditions similar to those of the DVD, the theoretical optical limit value is about 0.500 μm. In other words, this means that the actual optical limit value becomes 0.500 μm or larger. In some cases, this means that the track pitch Tp in the recording layer 63 may not be allowed to be 0.27 μm or smaller even if the first method described above is adopted, specifically, even if a method is adopted that allows the track pitch Tp in the recording layer 63 to be ½ of the track pitch in the reference surface Ref.

Therefore, in the fourth embodiment, there is proposed the second method as follows.

It is to be noted that, in the following example, the track pitch in the reference surface Ref may be set, for example, to about 0.800 μm.

Further, it is to be noted for confirmation that a structure of an optical disc recording medium targeted in the second method is similar to the multi-layered recording medium Dsc4 used in the above-described first method.

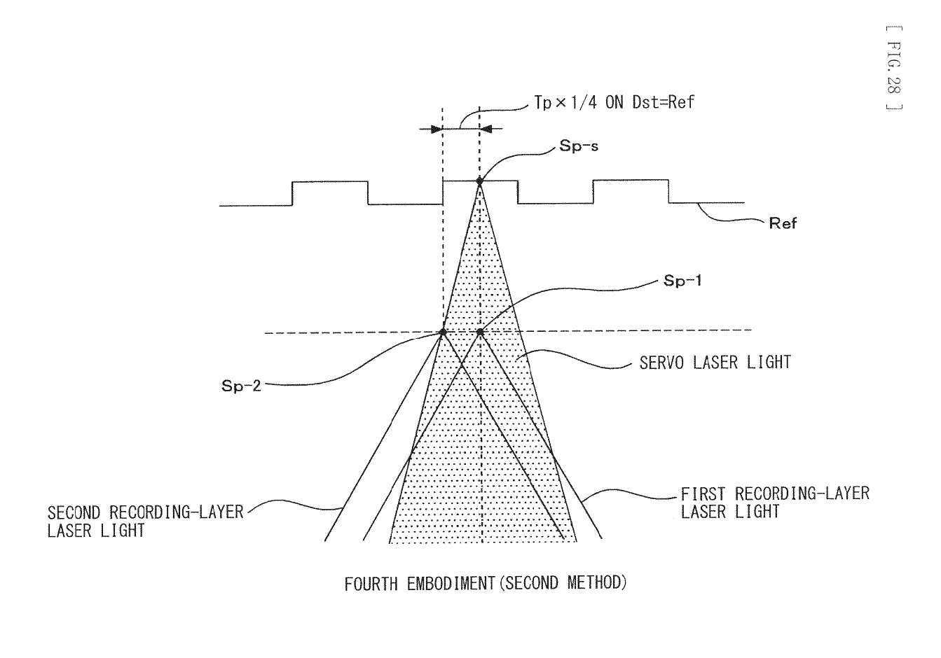

FIG. 28 is a diagram for explaining the second method in the fourth embodiment.

As shown in this FIG. 28, in the second method, the spot spacing Dst between the first spot Sp-1 of the first recording laser light and the second spot Sp-2 of the second recording-layer laser light is set to ¼ of the track pitch in the reference surface Ref.

In this case, the track pitch on the reference surface Ref is set to about 0.800 μm as described above. Therefore, the spot spacing Dst is 0.200 μm.

It is to be noted that, as clearly seen from the drawing, also in this case as with the first method described above, the optical axis of the first recording-layer laser light side is allowed to coincide with the optical axis of the servo laser light.

In the second method, the first recording-layer laser light and the second recording-layer laser light with which such a spot spacing Dst is set, mark recording operation is performed with respect to the recording layer 63 by a method as describe below.

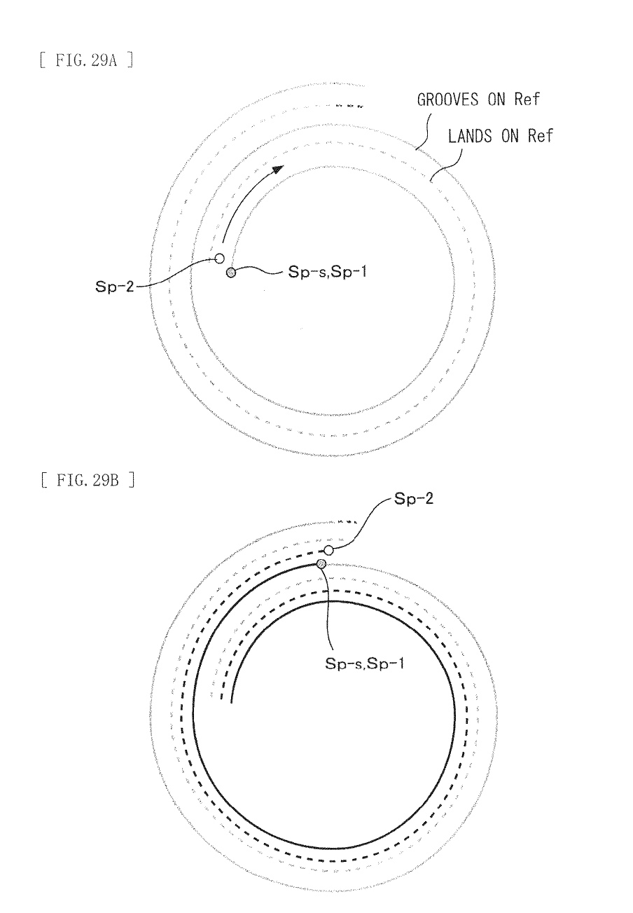

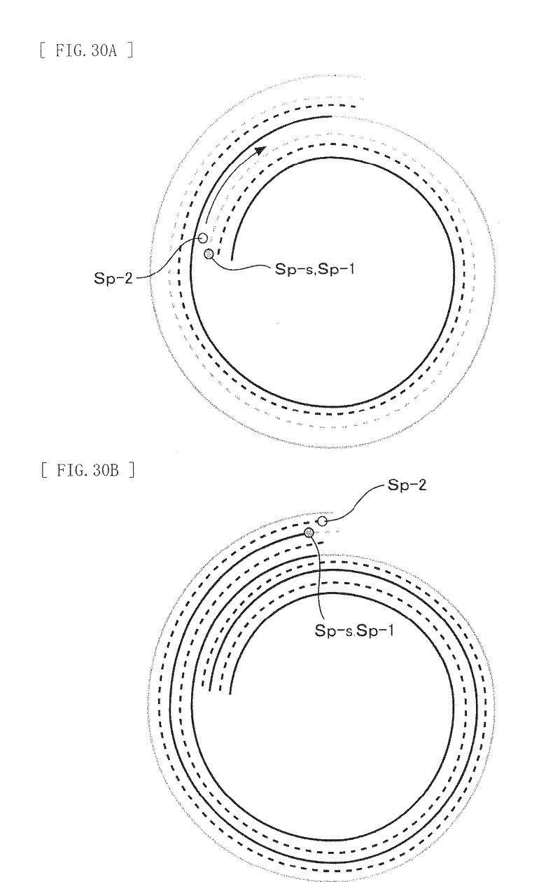

FIGS. 29A, 29B, 30A, and 30B are each a diagram for explaining a specific recording operation in the second method.

It is to be noted that, also in these FIGS. 29A, 29B, 30A, and 30B, as in the above-described FIGS. 25A and 25B, the gray line represents grooves (the position guides: the tracks) formed on the reference surface Ref, and the black line represents the tracks T formed in the targeted semitransparent recording film 61. Specifically, the solid line represents the grooved tracks T-g, and the dashed line represents the no-groove tracks T-s.

First, as a premise, the second method is similar to the first method in that two beams of the first recording-layer laser light and the second recording-layer laser light are used to perform recording operation of the grooved tracks T-g and recording operation of the no-groove tracks T-s in parallel at the same time.

The second method is different from the first method in that such concurrent recording operation of the grooved tracks T-g and the no-groove tracks T-s with the use of the two beams is executed in both of first and second tracking servo control modes. In the first tracking servo control mode, the servo light spot Sp-s is allowed to trace the grooves (the position guides) in the reference surface Ref. In the second tracking servo control mode, the servo light spot Sp-s is allowed to trace the land zones (zones between the position guides) in the reference surface Ref.

Specifically, in the recording operation in this case, first, as shown as a transition of FIG. 29A→FIG. 29B, concurrent recording operation of the grooved tracks T-g and the no-groove tracks T-s is performed with the use of the first and second recording-layer laser lights in the above-described first tracking servo control mode targeting the grooves in the reference surface Ref.

Moreover, after performing the recording operation, as shown as transition of FIG. 30A→FIG. 30B, concurrent recording operation of the grooved tracks T-g and the no-groove tracks T-s is performed with the use of the first and second recording-layer laser lights in the above-described second tracking servo control mode targeting the land zones in the reference surface Ref.

By such a recording operation in the second method, it is possible to perform recording operation with respect to the recording layer 63 in this case so that the grooved tracks (mark lines) T-g and the no-groove tracks (mark lines) T-s be arranged at a track pitch Tp that is ¼ of the track pitch of the reference surface Ref.

Accordingly, in the case of the present example, it is possible to achieve a track pitch Tp of about 0.200 μm, and it is possible to achieve an optical disc recording medium of the present technology which requires a track pitch Tp of 0.27 μm or smaller.

Here, at the time of reproducing operation of the multi-layered recording medium Dsc4 on which such mark recording operation is performed, the tracking servo control may be performed as follows.

Specifically, also in this case, two beams that are the first recording-layer laser light and the second recording-layer laser light are used as the reproducing beam as in the first method.

Moreover, tracking servo control of the objective lens 55 is performed based on the tracking error signal TE-r generated from the reflected light of the first recording-layer laser light. Accordingly, the first spot Sp-1 of the first recording-layer laser light is allowed to follow the grooved tracks T-g, and at the same time, the second spot Sp-2 of the second recording-layer laser light is allowed to follow the no-groove tracks T-s. Accordingly, as a result, it is possible to achieve concurrent reading operation of information recorded at the same time.

Also in the second method as described above, it is possible to achieve an optical disc system that allows tracking servo operation to be performed appropriately under a state where the tracks T are arranged at a pitch out of the optical limit value. Therefore, it is possible to further improve information recording density, and it is possible to further expand recording capacity.

It is to be noted that, in the above-described second method, performing tracking servo operation in different manners targeting the grooves/the lands in the reference surface Ref at the time of recording operation is allowed to be achieved by performing, in a switching manner, generation of the tracking servo signal TS-sv based on the tracking error signal TE-sv itself, and generation of the tracking servo signal TS-sv based on the signal obtained by performing polarity inversion or offset (offset corresponding to one turn) on the tracking error signal TE-sv in the servo-light servo circuit 96 shown in FIG. 27.

Moreover, a servo method at the time of reproducing by the above description is allowed to be achieved by a configuration similar to that of the recording-reproducing device 95 in the first method.

### 6. Modifications

Hereinabove, the respective embodiments according to the present technology have been described. However, the present technology should not be limited to the specific examples described above.

For example, in the description above, it is assumed that the push-pull signal P/P is used as the tracking error signal. However, the present technology is favorably applied, for example, also in a case of using other tracking error signal such as a DPP (Differential Push-Pull) signal and a DPD (Differential Phase Detection) signal.

Moreover, in the third and fourth embodiments, there is exemplified a case where the wavelength of the laser light for mark recording is about 405 nm and the wavelength of the servo laser light is about 650 nm. However, these wavelengths should not be limited to the exemplified numerical values.

Moreover, in the second and fourth embodiments, there is exemplified a case of performing double spiral recording operation with the use of two beams for the laser light for recording. However, three or more beams for recording may be used to perform triple-or-more spiral recording operation.

Moreover, in the second and fourth embodiments, there is exemplified a method of concurrently reading the recorded information of the grooved tracks T-g and the no-groove tracks T-s recorded in separated-spiral fashion with the use of a plurality of beams at the time of reproducing operation. However, it goes without saying that it is possible to perform reading operation using only one beam as the reproducing beam. In that case, servo operation is performed in different manners between for the grooved tracks T-g and the no-groove tracks T-s.

Specifically, when reading the data targeted for reproducing operation on the grooved track T-g, tracking servo operation (in the case of the present example, tracking servo operation with the use of the tracking error signal TE itself) targeting that grooved track T-g is performed to read the targeted data. Also, when reading the data targeted for reproducing operation on the no-groove track T-s, tracking servo operation (in the case of the present example, tracking servo operation with the use of a signal obtained by performing polarity inversion or offset on the tracking error signal TE) targeting that no-groove track T-s is performed to read the targeted data.

Moreover, in the third and fourth embodiments, the reference surface Ref is provided on the lower layer side of the recording layer 63. However, in reverse, the reference surface Ref may be provided on an upper layer side of the recording layer 63. In such a case, as the reflection film 65, a film that has properties of selectively transmitting light having a wavelength band same as that of the recording-layer laser light and of reflecting light having a wavelength other than that.

Moreover, the present technology may adopt configurations described below.

(1)

An exposure device including:

a rotation drive section driving a master disc to rotate; and

an exposure section performing exposure operation on the master disc under rotation by the rotation drive section, the exposure section thereby allowing simple pit lines and grooved pit lines to be arranged alternately in a radial direction at a track pitch of 0.27 micrometers or smaller, the simple pit lines each being configured of arranged pits, and the grooved pit lines each being configured of pits and grooves, the grooves being inserted between the pits.

(2)

The exposure device according to (1), wherein the exposure section performs, every time the master disc rotates by a predetermined rotation angle, alternate switching between an exposure operation for the simple pit lines and an exposure operation for the grooved pit lines.

(3)

The exposure device according to (1), wherein the exposure section performs, with use of a plurality of beams, concurrent exposure operation on the master disc, the concurrent exposure operation being directed to both the simple pit lines and the grooved pit lines.

(4)

A recording medium including:

simple tracks each configured of arranged pits or arranged marks; and

grooved tracks each configured of pits or marks and grooves, the grooves being inserted between the pits or between the marks,

wherein the simple tracks and the grooved tracks are arranged alternately in a radial direction at a track pitch of 0.27 micrometers or smaller.

(5)

A recording device including a recording section performing recording operation on a recording layer of a recording medium, the recording section thereby allowing simple mark lines and grooved mark lines to be arranged alternately in a radial direction of the recording medium at a track pitch of 0.27 micrometers or smaller, the simple mark lines being each configured of arranged marks, and the grooved mark lines being each configured of marks and grooves, the grooves being inserted between the marks.

(6)

The recording device according to (5), wherein the recording section records a mark line to the recording layer, the recording layer having no pre-groove and having a planar shape.

(7)

The recording device according to (6), further including:

a light irradiation section irradiating servo laser light and recording laser light to the recording medium, the servo laser light being irradiated to obtain reflection light from a reference surface, the recording laser light being irradiated to perform recording operation on the recording layer, the reference surface being formed in the recording medium together with the recording layer and including a position guide formed thereon; and

a position control section controlling, based on a light reception signal derived from reception of the reflection light of the servo laser light, an irradiation position in a tracking direction of the recording laser light irradiated to the recording medium.

(8)

The recording device according to (7), wherein

the light irradiation section is configured to irradiate the servo laser light to the recording medium through an objective lens, the objective lens being provided to be used, in common, for the servo laser light and the recording laser light, and

the position control section controls, based on the light reception signal derived from the servo laser light, a position of the objective lens in the tracking direction.

(9)

The recording device according to (7) or (8), wherein

the reference surface is formed to have a plurality of phases of pit lines, in which pit lines are formed in a fashion of spiral or concentric circle, the pit lines each having allowable positions in pit-formation, a spacing of the allowable positions in one pit-line turn being defined to a predetermined first distance, and location of a spacing between the allowable positions in a pit-formation direction is shifted by a predetermined second distance between every pit lines adjacent in the radial direction, and

the position control section controls, based on a light reception signal derived from reception of the reflection light of the servo laser light, the position of the objective lens in the tracking direction to allow the recording laser light to trace a spiral path having a pitch of 0.27 micrometers or smaller.

(10)

The recording device according to (7) or (8), wherein the recording section performs the recording operation on the recording layer to allow recording on both the simple mark line and the grooved pit line to be concurrently executed, with use of first laser light and second laser light as the recording laser light, the first laser light and the second laser light being irradiated to the recording layer to allow a radial spacing of spots to be half of a track pitch of the position guides formed in the reference surface.

(11)

The recording device according to (7) or (8), wherein

the recording section executes the recording operation on the recording layer both in a mode that allows the position control section to perform position control based on the position guides and in a mode that allows the position control section to perform position control based on land zones formed between the position guides, the recording operation allowing recording operation on both the simple mark line and the grooved pit line to be concurrently executed, with use of first laser light and second laser light as the recording laser light, the first laser light and the second laser light being irradiated to the recording layer to allow a radial spacing of spots to be one-fourth of a track pitch of the position guides formed in the reference surface.

(12)

A reproducing device including:

a light irradiation-reception section irradiating laser light to a recording medium through an objective lens and receiving reflected light of the irradiated laser light, the recording medium including simple tracks and grooved tracks arranged alternately in a radial direction at a track pitch of 0.27 micrometers or smaller, the simple tracks being configured of arranged pits or arranged marks, and the grooved tracks being configured of pits or marks and grooves, the grooves being inserted between the pits or between the marks;

a tracking error signal generation section generating a tracking error signal based on a light reception signal derived from the reflected light received by the light irradiation-reception section;

a position control section controlling a position of the objective lens in a tracking direction based on the tracking error signal, and thereby controlling a position of the laser light in the radial direction, the tracking direction being a direction parallel to the radial direction; and

a reproducing section performing reproduction operation of a recorded signal from the recording medium based on the light reception signal.

(13)

The reproducing device according to (12), wherein the position control section performs switching between position control based on a first control signal and position control based on a second control signal, in accordance with switching between a mode of position control based on the simple tracks and a mode of position control based on the grooved tracks,

the first control signal being a inverted-polarity signal of the tracking error signal or a offset signal of the tracking error signal, and the second control signal being a non-inverted-polarity signal of the tracking error signal or a non-offset signal of the tracking error signal.

This application claims priority on the basis of Japanese Patent Application JP 2011-278539 filed Dec. 20, 2011 in Japan Patent Office, the entire contents of each which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An exposure device comprising:
a rotation drive section driving a master disc to rotate; and
an exposure section performing exposure operation on the master disc under rotation by the rotation drive section, the exposure section thereby allowing simple pit lines and grooved pit lines to be arranged alternately in a radial direction at a track pitch of 0.27 micrometers or smaller, the simple pit lines each being configured of arranged pits, and the grooved pit lines each being configured of pits and grooves, the grooves being inserted between the pits.

2. The exposure device according to claim 1, wherein the exposure section performs, every time the master disc rotates by a predetermined rotation angle, alternate switching between an exposure operation for the simple pit lines and an exposure operation for the grooved pit lines.

3. The exposure device according to claim 1, wherein the exposure section performs, with use of a plurality of beams, concurrent exposure operation on the master disc, the concurrent exposure operation being directed to both the simple pit lines and the grooved pit lines.

4. A recording medium comprising:
simple tracks each configured of arranged pits or arranged marks; and
grooved tracks each configured of pits or marks and grooves, the grooves being inserted between the pits or between the marks,
wherein the simple tracks and the grooved tracks are arranged alternately in a radial direction at a track pitch of 0.27 micrometers or smaller.

5. A recording device comprising a recording section performing recording operation on a recording layer of a recording medium, the recording section thereby allowing simple mark lines and grooved mark lines to be arranged alternately in a radial direction of the recording medium at a track pitch of 0.27 micrometers or smaller, the simple mark lines being each configured of arranged marks, and the grooved mark lines being each configured of marks and grooves, the grooves being inserted between the marks.

6. The recording device according to claim 5, wherein the recording section records a mark line to the recording layer, the recording layer having no pre-groove and having a planar shape.

7. The recording device according to claim 6, further comprising:
a light irradiation section irradiating servo laser light and recording laser light to the recording medium, the servo laser light being irradiated to obtain reflection light from a reference surface, the recording laser light being irradiated to perform recording operation on the recording layer, the reference surface being formed in the recording medium together with the recording layer and including a position guide formed thereon; and
a position control section controlling, based on a light reception signal derived from reception of the reflection light of the servo laser light, an irradiation position in a tracking direction of the recording laser light irradiated to the recording medium.

8. The recording device according to claim 7, wherein
the light irradiation section is configured to irradiate the servo laser light to the recording medium through an objective lens, the objective lens being provided to be used, in common, for the servo laser light and the recording laser light, and
the position control section controls, based on the light reception signal derived from the servo laser light, a position of the objective lens in the tracking direction.

9. The recording device according to claim 8, wherein
the reference surface is formed to have a plurality of phases of pit lines, in which pit lines are formed in a fashion of spiral or concentric circle, the pit lines each having allowable positions in pit-formation, a spacing of the allowable positions in one pit-line turn being defined to a predetermined first distance, and location of a spacing between the allowable positions in a pit-formation direction is shifted by a predetermined second distance between every pit lines adjacent in the radial direction, and
the position control section controls, based on a light reception signal derived from reception of the reflection light of the servo laser light, the position of the objective lens in the tracking direction to allow the recording laser light to trace a spiral path having a pitch of 0.27 micrometers or smaller.

10. The recording device according to claim 7, wherein the recording section performs the recording operation on the recording layer to allow recording on both the simple mark line and the grooved pit line to be concurrently executed, with use of first laser light and second laser light as the recording laser light, the first laser light and the second laser light being irradiated to the recording layer to allow a radial spacing of spots to be half of a track pitch of the position guides formed in the reference surface.

11. The recording device according to claim 7, wherein
the recording section executes the recording operation on the recording layer both in a mode that allows the position control section to perform position control based on the position guides and in a mode that allows the position control section to perform position control based on land zones formed between the position guides, the recording operation allowing recording operation on both the simple mark line and the grooved pit line to be concurrently executed, with use of first laser light and second laser light as the recording laser light, the first laser light and the second laser light being irradiated to the recording layer to allow a radial spacing of spots to be one-fourth of a track pitch of the position guides formed in the reference surface.

12. A reproducing device comprising:
a light irradiation-reception section irradiating laser light to a recording medium through an objective lens and receiving reflected light of the irradiated laser light, the recording medium including simple tracks and grooved tracks arranged alternately in a radial direction at a track pitch of 0.27 micrometers or smaller, the simple tracks being configured of arranged pits or arranged marks, and the grooved tracks being configured of pits or marks and grooves, the grooves being inserted between the pits or between the marks;
a tracking error signal generation section generating a tracking error signal based on a light reception signal derived from the reflected light received by the light irradiation-reception section;
a position control section controlling a position of the objective lens in a tracking direction based on the tracking error signal, and thereby controlling a position of the laser light in the radial direction, the tracking direction being a direction parallel to the radial direction; and
a reproducing section performing reproduction operation of a recorded signal from the recording medium based on the light reception signal.

13. The reproducing device according to claim 12, wherein the position control section performs switching between position control based on a first control signal and position control based on a second control signal, in accordance with switching between a mode of position control based on the simple tracks and a mode of position control based on the grooved tracks,
the first control signal being a inverted-polarity signal of the tracking error signal or a offset signal of the tracking error signal, and the second control signal being a non-inverted-polarity signal of the tracking error signal or a non-offset signal of the tracking error signal.
